(19) United States
(12) Patent Application Publication
(10) Pub. No.: US 2024/0360341 A1
(43) Pub. Date: Oct. 31, 2024

(54) ADHESIVE TAPE, PROCESS FOR PRODUCING THE ADHESIVE TAPE, BONDED ASSEMBLY AND PROCESS FOR ELECTRICALLY SEPARATING THE BONDED ASSEMBLY

(71) Applicant: tesa SE, Norderstedt (DE)

(72) Inventors: Thorsten Krawinkel, Hamburg (DE); Shuang Wang, Hamburg (DE)

(73) Assignee: tesa SE, Norderstedt (DE)

(21) Appl. No.: 18/639,378

(22) Filed: Apr. 18, 2024

(30) Foreign Application Priority Data
Apr. 25, 2023 (EP) 23169917.4

(51) Int. Cl. C09J 7/28; C09J 11/04; C09J 11/06; C09J 133/10

(52) U.S. Cl. CPC C09J 7/28; C09J 11/04; C09J 11/06; C09J 133/10; C09J 2301/124; C09J 2301/16; C09J 2301/208; C09J 2301/302; C09J 2301/314; C09J 2301/408; C09J 2301/412; C09J 2301/502; C09J 2400/16; C09J 2433/00

(57) ABSTRACT

An adhesive tape, and adhesive tape assembly, that includes: a first layer of adhesive (D), the layer (D) comprising at least one electrolyte; a second layer of adhesive (C), the layer (C) being electrically conductive; and an electrically conductive carrier layer (T), the carrier layer (T) disposed between the first layer (D) and the second layer (C). Further, the layers (D), (T), and (C) are disposed one above another such that none of the layers (D), (T), and (C) laterally protrudes beyond any of the other layers (D), (T), and (C). The adhesive tape assembly can further include a first substrate (A) that is electrically conductive, a second substrate (B) disposed on a face of the second layer (C) that is opposite the carrier layer (T), and wherein the second layer (C) laterally protrudes beyond the substrate (B) such that the layer (C) has an exposed face.

### CROSS-REFERENCE TO RELATED APPLICATIONS

This application claims the benefit of priority under 35 U.S.C. § 119 (b) of European Patent Application No. EP23169917.4, entitled “ADHESIVE TAPE, PROCESS FOR PRODUCING THE ADHESIVE TAPE, BONDED ASSEMBLY AND PROCESS FOR ELECTRICALLY SEPARATING THE BONDED ASSEMBLY”, and filed Apr. 25, 2023, the contents of which is relied upon and incorporated herein by reference in its entirety.

### FIELD OF THE DISCLOSURE

The invention relates to an adhesive tape, to a process for producing the adhesive tape, to an adhesively bonded assembly, to a process for electrically separating the bonded assembly, and to the use of the adhesive tape for bonding components in electronic devices, automobiles, medical devices, and dental devices.

### BACKGROUND

The majority of adhesive tape solutions are not at all detachable, or not detachable without damage to the substrates. Recently there has been an increased interest in “debonding-on-demand” functionalities, having come about owing to environmental laws and/or to the awareness on the part of the end customers of sustainability, and to an increasing cost pressure affecting production. The application scenarios for debonding processes are classified into reworking, repairing, recycling, and processing aids.

The debonding technologies are aimed at achieving cohesive splitting of the layer of adhesive, or adhesive detachment of the layer of adhesive from the substrate. While the former requires cleaning of the substrate prior to rebonding, the latter manages without it. Adhesive-separating technologies which guarantee the requisite high and durably reliable bond strength, however, are generally more difficult to realize or take a very long time to apply, such as detachment by means of an undermining solvent, for example.

At the present time, accordingly, especially in the reworking or repair of electronic devices, such as smartphones and tablet computers, for example, the adhesive bonds used are primarily cohesively splitting bonds, in many cases implemented in the form of pressure-sensitive adhesive tapes, which through an increase in temperature have their cohesion diminished to an extent such that the bond can be parted manually, cohesively. Extensive reworking to prepare the substrate surface, contaminated with remnants of adhesive, for rebonding is the consequence.

Alongside heat-mediated parting processes, electrical parting processes are discussed. Thus, for example, EP 3363873 B1 discloses one such electrical parting process and a corresponding double-sided adhesive tape which enables electrical parting of substrates bonded to one another. The intention of this in particular is to enable the parting of rigid substrates. For this purpose, the adhesive tape proposed in EP 3363873 B1 features a centrally disposed, electrically conductive layer, surrounded by two layers of adhesive, of which one adhesive layer contains an electrolyte and so can be separated electrically from the conductive layer or from an electrically conductive substrate. The adhesive parting of the layer of adhesive from the centrally disposed, electrically conductive layer has the disadvantage, however, that as a result the parting takes place within the adhesive tape and hence remnants of the adhesive tape remain on both substrates. Further, in the case of the adhesive tape proposed in EP 3363873 B1, there is an extension portion of the centrally disposed, electrically conductive layer provided that makes it possible for a voltage to be applied to this layer. A disadvantage of an extension portion of this kind, however, is that because of the nonuniform dimensions of the conductive layer and the layers of adhesive, the adhesive tape is comparatively complicated to produce. The reason is that the layers must be diecut separately from one another and can only be assembled subsequently to give an adhesive tape having the appropriate dimensions.

Therefore, there is a need, proceeding from the prior art, to provide an adhesive tape and a process for producing the adhesive tape where the adhesive tape is to be redetachable from at least one substrate without remnants and is to be relatively simple to produce. At the same time, the peel adhesion of the adhesive tape to the substrates to be bonded is not to be adversely affected prior to separation.

### SUMMARY OF THE DISCLOSURE

According to an aspect of the disclosure, an adhesive tape is provided that includes: a first layer of adhesive (D), the layer (D) comprising at least one electrolyte; a second layer of adhesive (C), the layer (C) being electrically conductive; and an electrically conductive carrier layer (T), the carrier layer (T) disposed between the first layer (D) and the second layer (C). Further, the layers (D), (T), and (C) are disposed one above another such that none of the layers (D), (T), and (C) laterally protrudes beyond any of the other layers (D), (T), and (C).

According to another aspect of the disclosure, a process for producing an adhesive tape is provided that includes: a) providing a first layer of adhesive (D), the layer of adhesive (D) comprising at least one electrolyte; b) providing an electrically conductive carrier layer (T); c) providing a second layer of adhesive (C), the layer of adhesive (C) being electrically conductive; d) disposing the carrier layer (T) between the layers (D) and (C) to define an adhesive tape (DTC), the tape (DTC) configured as a double-sided adhesive tape; and e) optionally shaping the adhesive tape (DTC).

According to a further aspect of the disclosure, an adhesive tape assembly is provided that includes: a first substrate (A), the substrate (A) being electrically conductive; a first layer of adhesive (D) disposed on a face of the substrate (A), the layer of adhesive (D) comprising at least one electrolyte; an electrically conductive carrier layer (T) disposed on a face of the first layer of adhesive (D) that is opposite the substrate (A); a second layer of adhesive (C), the layer of adhesive (C) being electrically conductive and being disposed on a face of the carrier layer (T) that is opposite the first layer of adhesive (D); and a second substrate (B), the substrate (B) is disposed on a face of the second layer of adhesive (C) that is opposite the carrier layer (T). The second layer of adhesive (C) laterally protrudes beyond the substrate (B) such that the layer of adhesive (C) has an exposed free face. Further, the layers (D), (T), and (C) are disposed one above another such that none of the layers (D), (T), and (C) laterally protrudes beyond any of the other layers (D), (T), and (C).

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the disclosure and the appended claims.

The accompanying drawings are included to provide a further understanding, and are incorporated in and constitute a part of this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following embodiments.

### BRIEF DESCRIPTION OF DRAWINGS

Further details and features of the present invention are apparent from the description of figures and working examples. Here, the respective features may be realized on their own or as two or more in combination with one another. The invention is not confined to the working examples. The working examples are represented schematically in the figures. Identical reference numerals in the individual figures here denote identical or functionally identical elements or elements which correspond to one another in terms of their functions.

FIG. 1 shows a simplified schematic cross section through a double-sided bonding element (adhesive tape) of the invention in a preferred embodiment;

FIG. 2A shows a simplified schematic cross section through a bonded assembly (adhesive tape assembly) of the invention in a preferred embodiment;

FIG. 2B shows a simplified schematic cross section through a bonded assembly of the invention, to which a voltage is applied, in a preferred embodiment; and

FIG. 2C shows a simplified schematic cross section through a bonded assembly of the invention after a voltage has been applied and has resulted in adhesive splitting.

### DETAILED DESCRIPTION

In the following detailed description, for purposes of explanation and not limitation, example embodiments disclosing specific details are set forth to provide a thorough understanding of various principles of the adhesive tape of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or description that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used herein, the singular forms “a,” “an,” and “the” include plural referents unless the context clearly dictates otherwise. Thus, for example, reference to a “component” includes aspects having two or more such components, unless the context clearly indicates otherwise.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

All of the statements in the description apply to the adhesive tape of the invention, to the process of the invention for producing the adhesive tape, to the adhesively bonded assembly of the invention, to the process for electrically separating the assembly, and to the use of the adhesive tape of the invention.

The invention, moreover, embraces all the features which are subjects of any dependent claims. Further, the invention embraces combinations of individual features with one another, including at different preference levels. The invention thus embraces, for example, the combination of a first feature identified as being “preferred” with a second feature identified as being “particularly preferred”. In this context, subjects identified as part of “embodiments”, likewise at different preference levels, are also embraced.

The adhesive tape of the invention comprises at least layers as follows:
a first layer D of adhesive, the layer D of adhesive containing at least one electrolyte;
a second layer C of adhesive, the layer C of adhesive being electrically conductive; and
an electrically conductive carrier layer T, which is disposed between the first layer D of adhesive and the second layer C of adhesive,

where the layers T, C, and D are preferably disposed one above another such that none of the layers laterally protrudes beyond any of the other layers.

The adhesive tape of the invention is a double-sided adhesive tape. For the sake of simplicity, the double-sided adhesive tape of the invention is also referred to in the context of the present invention as “adhesive tape”. Because the adhesive tape containing the first layer D of adhesive comprises at least one electrolyte, it is electrically redetachable. Because the second layer C of adhesive and the carrier layer T are electrically conductive, it is possible to apply a voltage to the second layer C of adhesive and to an electrically conductive substrate bonded to the first layer D of adhesive, to separate the adhesive tape from the substrate via the first layer D of adhesive.

Through the combination of the detachable layer D of adhesive and the conductive layers T and C, therefore, it is possible to detach the adhesive tape adhesively from at least one substrate. This has the advantage that no remnants of the adhesive tape remain on this same substrate.

The layers D, T, and C are preferably disposed one above another such that none of the layers laterally protrudes beyond any of the other layers. As a result, the adhesive tape is comparatively simple to produce. The reason is that the layers T, C, and D may be disposed relative to one another in accordance with the invention and subsequently the layered assembly jointly or the adhesive tape may be diecut or otherwise brought into the desired shape. As a result, the adhesion of the layers D, T, and C can also be optimally adjusted relative to one another more easily, and so this need not take place at a later point in time.

Hence the process of the invention for producing the adhesive tape of the invention comprises at least process steps as follows:
a) providing a first layer D of adhesive, the layer D of adhesive comprising at least one electrolyte;
b) providing an electrically conductive carrier layer T;
c) providing a second layer C of adhesive, the layer C of adhesive being electrically conductive;
d) disposing the layers D, T, and C, to give a layered assembly DTC as a double-sided adhesive tape; and
e) optionally shaping, more particularly diecutting or slitting, the layered assembly DTC.

The shaping, more particularly diecutting or slitting, in step e) is optional, since according to preferred embodiments of the invention, the layers D, T, and C are already provided in the desired uniform dimensions, meaning that in that case there is no need for additional diecutting or slitting. In the context of “slitting”, lasers are preferably employed. Further details of steps a) to e) are set out further below.

For numerous industrial applications, however, the adhesive tape, according to further preferred embodiments, is produced in such a way as to permit economical storage and use, more particularly in the form of rolls. In that case, individual adaptation to the particular dimensions is needed, especially for the use of the adhesive tape for bonding components in electronic devices, automobiles, medical devices, and dental devices.

A further subject of the present invention is an adhesively bonded assembly comprising at least layers as follows:
a first substrate A, the substrate A being electrically conductive;
a first layer D of adhesive disposed at least on one of the faces of the substrate A, the layer D of adhesive containing at least one electrolyte;
an electrically conductive carrier layer T disposed on the face of the first layer D of adhesive that is opposite the substrate A;
a second layer C of adhesive, the layer C of adhesive being electrically conductive and being disposed on the face of the carrier layer T that is opposite the first layer D of adhesive;
a second substrate B, which is disposed on the face of the second layer C of adhesive that is opposite the carrier layer T,
where the second layer C of adhesive laterally protrudes beyond the substrate B in at least one direction of extent of the layer plane, and
where the layers D, T, and C are preferably disposed one above another such that none of the layers D, T, and C laterally protrudes beyond any of the other layers D, T, and C.

The bonded assembly of the invention therefore includes the adhesive tape of the invention and substrates A and B bonded to one another by way of said tape.

Because the second layer C of adhesive laterally protrudes beyond the substrate B in at least one direction of extent of the layer plane and hence has a free face or a free face portion, a voltage can be applied to this second layer C of adhesive without any need for an extension portion of the layer C that goes beyond the layers T and D. Correspondingly, in the adhesive tape of the invention and the bonded assembly, it is preferable for none of the layers D, T, and C to laterally protrude beyond any of the other layers D, T, and C.

In accordance with the invention, the first substrate A is electrically conductive, and so a voltage can be applied here. The second substrate B need not be electrically conductive. Through the adhesive tape of the invention, therefore, substrates can be bonded to one another and electrically separated from one another again without both substrates having to be electrically conductive. The electrically conductive substrate A may be, for example, a casing of a cellphone. The substrate B may be, in particular, a battery or other components not of electrically conductive design, such as speakers, for example.

A further subject of the present invention is a process for electrically separating the assembly of the invention.

The process comprises at least process steps as follows:
i.) applying a voltage between the conductive substrate A and the second layer C of adhesive, the voltage being preferably 2 to 20 V, with particular preference 3 to 15 V.

The voltage is applied according to step i.) of the process of the invention to electrically separate the assembly. The voltage in question is more particularly a direct-current voltage. The temporal duration for which the voltage is applied in step i.) here may be from a few seconds, more particularly 2 seconds, up to 300 seconds, preferably up to 120 seconds.

Without wishing to be tied to any particular theory, the inventors assume the mechanism to be as follows: As a result of the voltage being applied, the electrolyte undergoes migration, more particularly a parting of the anions and cations of an ionic liquid, in the layer D of adhesive. This greatly lowers the adhesion of the layer D of adhesive to the substrate A, and these layers separate from one another.

If the layers after the voltage has been applied do not separate from one another without further exertion, the process of the invention comprises at least the further process step of:
ii.) exerting force on the layer D of adhesive and/or on the substrate A, to increase the distance between A and D.

Through the process of the invention for electrically separating the assembly of the invention, the adhesive tape can be separated from the substrate A in a simple way without remnants of the adhesive tape remaining on the surface of the substrate A.

A further subject of the present invention is the use of the adhesive tape of the invention for bonding components in electronic devices, automobiles, medical devices, and dental devices. In the course of the use in accordance with the invention, in particular, an assembly of the invention is generated, in which the second layer C of adhesive laterally protrudes beyond the substrate B in at least one direction of extent of the layer plane.

The present invention relates to an adhesive tape which may take any desired converted form, with adhesive tape rolls being preferred. The adhesive tape, more particularly in web form, may be produced either in the form of a roll, i.e., in the form of an Archimedean spiral rolled up onto itself, or as an adhesive strip, of the kind obtained in the form of diecuts, for example.

The adhesive tape of the invention is present more particularly in web form. A web refers to an object whose length (extent in x direction) is greater by a multiple than its width (extent in y direction) and the width is approximately, preferably exactly, the same along the entire length.

The general expression “adhesive tape”, synonymously also called “adhesive strip”, in the sense of this invention encompasses all sheetlike structures, such as two-dimensionally extended films or film portions, tapes with extended length and limited width, tape portions and the like, lastly also diecuts or labels.

As well as the lengthwise extent (x direction) and widthwise extent (y direction), the adhesive tape also has a thickness (z direction), extending perpendicularly to both extents, with the widthwise extent and lengthwise extent being greater by a multiple than the thickness. The thickness is extremely similar, preferably exactly the same, over the entire two-dimensional extent of the adhesive tapes as defined by length and width. The statements apply analogously to the carrier layer T, which as an integral constituent of the adhesive tape forms a layer in x and y directions. It will be appreciated that the individual layers are disposed one atop another along the z direction.

The expression “laterally protrude” refers in the context of the present invention to any kind of lateral protrusion of the layer or layers in question and means that the particular layer in question extends further, particularly in the “xy” plane and hence laterally-perpendicular to the stack direction—than does the reference layer. In place of the term “lateral protrusion”, terms used in the context of the present invention include “lateral extension” or “lateral extension portion”.

The term “lateral” is referenced here to any direction of extent of the layer plane “xy” perpendicularly to the stack direction of the layers “2”. The term is therefore independent in particular of the geometric shape of the adhesive tape in the “xy” plane, which for example may be a rectangle, as is usual for adhesive tapes (see above), or else may be a square or a circle.

Minor fluctuations in the dimensions of the individual layers in the “xy” plane, resulting from the diecutting process or similar shaping processes, are not addressed herewith, in particular since such slight projections of material, in view of the dimensions, are incapable of receiving a voltage applied thereto as planned and they do not imply any additional effort in production, thus being not brought about by means of an additional process step.

In the text below, the individual layers D, T, and C are set out further.

The layer D of adhesive contains at least one electrolyte. An “electrolyte” refers presently to a chemical compound “which in the solid, liquid or dissolved state is dissociated into ions and which undergoes directed movement under the influence of an electrical field”, as recited in the German Wikipedia entry “Electrolyte” of Jan. 4, 2023 and correspondingly in Carl H. Hamann, Wolf Vielstich: Elektrochemie I: Elektrolytische Leitfähigkeit, Potentiale, Phasengrenzen [Electrochemistry I: Electrolytic conductivity, Potentials, Phase boundaries], 2nd edition, VCH Verlagsgesellschaft mbH, Oldenburg/Bonn 1985, ISBN 3-527-21100-4, p. 4. The electrolyte of the layer D of adhesive is preferably selected from the group consisting of ionic liquids and metal salts, with ionic liquids being particularly preferred.

In particular through one or more ionic liquids as electrolyte, the adhesive tape can be redetached in a simple way without adversely affecting the adhesive properties of the adhesive tape. Ionic liquids have the advantage here that they can be distributed readily and homogeneously in the polymer matrix of adhesives and the redetachment functions more quickly than with other electrolytes.

Further, the constituents of ionic liquids, especially at room temperature, are not volatile. Ionic liquids, moreover, are comparatively heat-stable and nonflammable and also comparatively stable chemically. Ionic liquids in the context of the present invention are salts which are liquid at room temperature, i.e., 23° C. Ionic liquids accordingly contain anions and cations. Ionic liquids are therefore especially suitable as electrolyte in the context of the parting process of the invention or process for electrical separation.

When a voltage is applied, the anions migrate to the anodic side and the cations to the cathodic side. As a result, the peel adhesion of the layer of adhesive containing the ionic liquid, presently layer D, to the substrate, presently, in particular, substrate A, is lowered, thereby achieving adhesive splitting between the layer D of adhesive and the substrate A.

In the context of the present invention, in principle all ionic liquids are suitable. The ionic liquids used in the context of the present invention contain at least one anion and at least one cation. It is also conceivable here for the ionic liquid to comprise two or more types of anions and/or two or more types of cations. It is conceivable, further, for two or more different ionic liquids to be added to the layer D of adhesive, meaning that the layer D of adhesive then contains two or more different ionic liquids.

The anion of the ionic liquid is preferably selected from the group consisting of Br⁻, AlCl₄⁻, Al₂Cl₇⁻, NO₃⁻, BF₄⁻, PF₆⁻, CH₃COO⁻, CF₃COO⁻, CF₃CO₃⁻, CF₃SO₃⁻, (CF₃SO₂)₂N⁻, (CF₃SO₂)₃C⁻, AsF₆⁻, SbF₆⁻, CF₃(CF₂)₃SO₃⁻ (CF₃CF₂SO₂)₂N⁻, CF₃CF₂CF₂COO⁻, and (FSO₂)₂N⁻. These anions are particularly readily soluble in polymers which are used in adhesives, such as (meth)acrylates, and are able to diffuse through the matrix quickly enough to permit a comparatively quick parting process. At the same time, no remnants are left. With particular preference, the anion is selected from the group consisting of (CF₃SO₂)₂N⁻ and (FSO₂)₂N⁻. These anions are especially suitable since they achieve the best electrical detachability. In particular, (re)detachment with these anions is particularly quick and no remnants are left.

The cation of the ionic liquid is preferably selected from the group consisting of imidazolium-based cations, pyridinium-based cations, pyrrolidine-based cations, and ammonium-based cations. These cations are particularly readily soluble in polymers which are used in adhesives, such as (meth)acrylates, and are able to diffuse through the matrix quickly enough to permit a comparatively quick parting process. At the same time, no remnants are left. With particular preference, the cation is selected from the group consisting of imidazolium-based cations. These cations are especially suitable since they achieve the best electrical detachability. In particular, (re)detachment with these cations is particularly quick and no remnants are left. With further preference, the cation is selected from the group consisting of 1-ethyl-3-methylimidazolium and 1-butyl-3-methylimidazolium. With preference in turn the cation is 1-ethyl-3-methylimidazolium.

With particular preference, the electrolyte of the layer D of adhesive is selected from the group consisting of the ionic liquids 1-ethyl-3-methylimidazolium bis(trifluoromethylsulfonyl)imide (EMIM-TFSI) and 1-ethyl-3-methylimidazolium bis(fluorosulfonyl)imide (EMIM-FSI). These ionic liquids are particularly readily soluble in polymers which are used in adhesives, such as (meth)acrylates, and are able to diffuse through the matrix quickly enough to permit a comparatively quick parting process. At the same time, no remnants are left. The composition of the first layer D of adhesive preferably contains at least one polymer.

The first layer D of adhesive is with particular preference poly(meth)acrylate-based. The expression “(meth)acrylate-based” in the context of the present invention is intended to mean that poly(meth)acrylates constitute the main polymers of the adhesive and accordingly are contained at 90% to 100% by weight in the layer D of adhesive, based here on 100% by weight, i.e., based on the total amount of polymers contained in the layer D of adhesive. Any tackifier resins contained in the layer D of adhesive are not counted among the 100% by weight of polymers contained. Where the layer of adhesive contains less than 100% by weight (based on the total amount of polymers contained) of poly(meth)acrylates, it contains at least one further type of polymer.

With particular preference, 100% by weight of the polymers contained in the layer D of adhesive are poly(meth)acrylates. The poly(meth)acrylates of all embodiments may in principle be any poly(meth)acrylates which are suitable for use in adhesives. A “poly(meth)acrylate” refers to a polymer which is obtainable in particular by radical or anionic polymerization of acrylic and/or methacrylic monomers and also, optionally, further, copolymerizable monomers. A “poly(meth)acrylate” refers more particularly to a polymer for which the monomer basis consists to an extent of at least 50% by weight of acrylic acid, methacrylic acid, acrylic esters and/or methacrylic esters, with acrylic esters and/or methacrylic esters being contained at least fractionally, preferably to an extent of at least 30% by weight, based on the overall monomer basis of the polymer in question.

The poly(meth)acrylate preferably contains at least fractionally copolymerized functional monomers, with particular preference monomers of at least one kind having at least one functional group selected from the group consisting of carboxylic acid groups, sulfonic acid groups, phosphonic acid groups, hydroxyl groups, acid anhydride groups, epoxide groups, and amino groups. The stated groups, with the exception of epoxide groups, exhibit reactivity with epoxide groups, so rendering the poly(meth)acrylate advantageously amenable to thermal crosslinking with introduced epoxides.

With particular preference, the poly(meth)acrylate contains at least fractionally copolymerized functional monomers, with particular preference monomers of at least one kind having at least one functional group selected from the group consisting of carboxylic acid groups, and epoxide groups; more particularly, it contains at least one carboxylic acid group. According to particularly advantageous embodiments, the poly(meth)acrylate contains fractionally copolymerized acrylic acid and/or methacrylic acid. By virtue of the carboxylic acid groups, this gives the poly(meth)acrylate reactivity with epoxide groups, so rendering the poly(meth)acrylate advantageously amenable to thermal crosslinking with introduced epoxides.

The poly(meth)acrylate may originate preferably from the following monomer composition:
a) at least one acrylic ester and/or methacrylic ester of the following Formula (1)

CH₂═C(R^{I})(COOR^{II}), (1)
in which R^{I}=H or CH₃ and R^{II} is an alkyl radical having 4 to 18 carbon atoms;
b) at least one olefinically unsaturated monomer having at least one functional group selected from the group consisting of carboxylic acid groups, sulfonic acid groups, phosphonic acid groups, hydroxyl groups, acid anhydride groups, epoxide groups, and amino groups; and
c) optionally further acrylic esters and/or methacrylic esters and/or olefinically unsaturated monomers which are copolymerizable with the component (a).

According to one particularly advantageous embodiment, the poly(meth)acrylate is based on a monomer composition which contains monomers of group a) with a fraction of 93% to 99% by weight and monomers of group b) with a fraction of 1% to 7% by weight.

With a poly(meth)acrylate of this kind in the layer D of adhesive in the adhesive tape of the invention, the resulting profile of properties, encompassing the tack, the shock resistance, and the capacity for remnant-free detachment, is particularly good.

The monomers of component (a) are generally plasticizing, comparatively nonpolar monomers. More preferably, R^{II} in the monomers a) is an alkyl radical having 4 to 10 carbon atoms. The monomers of the Formula (1) are more particularly selected from the group consisting of n-butyl acrylate, n-butyl methacrylate, n-pentyl acrylate, n-pentyl methacrylate, n-amyl acrylate, n-hexyl acrylate, n-hexyl methacrylate, n-heptyl acrylate, n-octyl acrylate, n-octyl methacrylate, n-nonyl acrylate, isobutyl acrylate, isooctyl acrylate, isooctyl methacrylate, 2-ethylhexyl acrylate, 2-ethylhexyl methacrylate, 2-propylheptyl acrylate, and 2-propylheptyl methacrylate. With particular preference, the monomers of the Formula (1) or of group a) are selected from the group consisting of n-butyl acrylate, n-hexyl acrylate, n-octyl acrylate, isooctyl acrylate, 2-ethylhexyl acrylate, and 2-propylheptyl acrylate.

The stated monomers are particularly amenable to polymerization and the glass transition temperature of the poly(meth)acrylate prepared is particularly amenable to adjustment. As a result, in turn, optimized properties can be achieved in terms of the flowability and tack, which are also adapted to the particular substrate or component that is to be bonded. Here, the monomers of the Formula (1) or of group a) are in turn preferably selected from the group consisting of n-butyl acrylate, isooctyl acrylate, and 2-ethylhexyl acrylate. Special preference is given to the use, as monomers of the Formula (1) or of group a), of n-butyl acrylate and 2-ethylhexyl acrylate.

The monomers of group b) are with particular preference selected from the group consisting of acrylic acid, methacrylic acid, itaconic acid, maleic acid, fumaric acid, crotonic acid, aconitic acid, dimethylacrylic acid, β-acryloyloxypropionic acid, trichloroacrylic acid, vinylacetic acid, vinylphosphonic acid, maleic anhydride, hydroxyethyl acrylate, 2-hydroxyethyl acrylate, hydroxypropyl acrylate, 3-hydroxypropyl acrylate, hydroxybutyl acrylate, 4-hydroxybutyl acrylate, hydroxyhexyl acrylate, 6-hydroxyhexyl acrylate, hydroxyethyl methacrylate, 2-hydroxyethyl methacrylate, hydroxypropyl methacrylate, 3-hydroxypropyl methacrylate, hydroxybutyl methacrylate, 4-hydroxybutyl methacrylate, hydroxyhexyl methacrylate, 6-hydroxyhexyl methacrylate, allyl alcohol, glycidyl acrylate, and glycidyl methacrylate. The monomers of group b) are preferably selected from acrylic acid, methacrylic acid, and hydroxyethyl acrylate. Special preference is given to the use, as monomers of group b), of acrylic acid.

Illustrative monomers of component c) are: methyl acrylate, ethyl acrylate, propyl acrylate, methyl methacrylate, ethyl methacrylate, benzyl acrylate, benzyl methacrylate, sec-butyl acrylate, tert-butyl acrylate, phenyl acrylate, phenyl methacrylate, isobornyl acrylate, isobornyl methacrylate, tert-butylphenyl acrylate, tert-butylphenyl methacrylate, dodecyl methacrylate, isodecyl acrylate, lauryl acrylate, n-undecyl acrylate, stearyl acrylate, tridecyl acrylate, behenyl acrylate, cyclohexyl methacrylate, cyclopentyl methacrylate, phenoxyethyl acrylate, phenoxyethyl methacrylate, 2-butoxyethyl methacrylate, 2-butoxyethyl acrylate, 3,3,5-trimethylcyclohexyl acrylate, 3,5-dimethyladamantyl acrylate, 4-cumylphenyl methacrylate, cyanoethyl acrylate, cyanoethyl methacrylate, 4-biphenyl acrylate, 4-biphenyl methacrylate, 2-naphthyl acrylate, 2-naphthyl methacrylate, tetrahydrofurfuryl acrylate, diethylaminoethyl acrylate, diethylaminocthyl methacrylate, dimethylaminoethyl acrylate, dimethylaminocthyl methacrylate, methyl 3-methoxyacrylate, 3-methoxybutyl acrylate, 2-phenoxyethyl methacrylate, butyldiglycol methacrylate, ethylene glycol acrylate, ethylene glycol monomethyl acrylate, methoxy polyethylene glycol methacrylate 350, methoxy polyethylene glycol methacrylate 500, propylene glycol monomethacrylate, butoxy diethylene glycol methacrylate, ethoxy triethylene glycol methacrylate, octafluoropentyl acrylate, octafluoropentyl methacrylate, 2,2,2-trifluoroethyl methacrylate, 1,1,1,3,3,3-hexafluoroisopropyl acrylate, 1,1,1,3,3,3-hexafluoroisopropyl methacrylate, 2,2,3,3,3-pentafluoropropyl methacrylate, 2,2,3,4,4,4-hexafluorobutyl methacrylate, 2,2,3,3,4,4,4-heptafluorobutyl acrylate, 2,2,3,3,4,4,4-heptafluorobutyl methacrylate, 2,2,3,3,4,4,5,5,6,6,7,7,8,8,8-pentadecafluorooctyl methacrylate, dimethyl-aminopropylacrylamide, dimethylaminopropylmethacrylamide, N-(1-methylundecyl)acrylamide, N-(n-butoxymethyl)acrylamide, N-(butoxymethyl)methacrylamide, N-(ethoxymethyl)acrylamide, N-(n-octadecyl)acrylamide; N,N-dialkyl-substituted amides, for example N,N-dimethylacrylamide and N,N-dimethylmethacrylamide; N-benzylacrylamide, N-isopropylacrylamide, N-tert-butylacrylamide, N-tert-octylacrylamide, N-methylolacrylamide, N-methylolmethacrylamide, acrylonitrile, methacrylonitrile; vinyl ethers such as vinyl methyl ether, ethyl vinyl ether, vinyl isobutyl ether; vinyl esters such as vinyl acetate; vinyl halides, vinylidene halides, vinylpyridine, 4-vinylpyridine, N-vinylphthalimide, N-vinyllactam, N-vinylpyrrolidone, styrene, α- and p-methylstyrene, α-butylstyrene, 4-n-butylstyrene, 4-n-decylstyrene, 3,4-dimethoxystyrene; macromonomers such as 2-polystyreneethyl methacrylate (weight-average molecular weight M_{w}, determined by GPC, of 4000 to 13000 g/mol), poly(methyl methacrylate)ethyl methacrylate (M_{w} of 2000 to 8000 g/mol).

Monomers of component c) may advantageously also be chosen such that they contain functional groups that assist subsequent radiochemical crosslinking (for example by electron beams or UV radiation). Suitable copolymerizable photoinitiators are, for example, benzoin acrylate and acrylate-functionalized benzophenone derivatives. Monomers that assist crosslinking by electron bombardment are, for example, tetrahydrofurfuryl acrylate, N-tert-butylacrylamide, and allyl acrylate.

The poly(meth)acrylate is preferably a polyacrylate prepared by polymerization of n-butyl acrylate and/or n-hexyl acrylate and/or n-octyl acrylate and/or isooctyl acrylate and/or 2-ethylhexyl acrylate and/or 2-propylheptyl acrylate and acrylic acid. The poly(meth)acrylate is with particular preference a polyacrylate prepared by polymerization of n-butyl acrylate, 2-ethylhexyl acrylate and acrylic acid. This gives the adhesive tape of the invention a particularly high peel adhesion.

The preparation of the poly(meth)acrylates is preferably accomplished by conventional radical polymerizations or controlled radical polymerizations. The poly(meth)acrylates can be prepared by copolymerization of the monomers using customary polymerization initiators and optionally chain transfer agents, by polymerization at the customary temperatures in bulk, in emulsion, for example in water or liquid hydrocarbons, or in solution. The poly(meth)acrylates are preferably prepared by copolymerizing the monomers in solvents, more preferably in solvents having a boiling range of 50 to 150° C., especially of 60 to 120° C., using 0.01% to 5% by weight, especially 0.1% to 2% by weight, based in each case on the total weight of the monomers, of polymerization initiators.

All customary initiators are suitable in principle. Examples of radical sources are peroxides, hydroperoxides, and azo compounds, for example bis(4-tert-butylcyclohexyl) peroxydicarbonate, dibenzoyl peroxide, cumene hydroperoxide, cyclohexanone peroxide, di-t-butyl peroxide, cyclohexylsulfonylacetyl peroxide, diisopropyl percarbonate, t-butyl peroctoate, and benzopinacol. Preferred radical initiators are 2,2′-azobis(2-methylbutyronitrile) (Vazo® 67™ from DuPont) or 2,2′-azobis(2-methylpropionitrile) (2,2′-azobisisobutyronitrile; AIBN; Vazo® 64™ from DuPont). According to preferred embodiments, bis(4-tert-butylcyclohexyl) peroxydicarbonate is used.

Preferred solvents for the preparation of the poly(meth)acrylates are alcohols such as methanol, ethanol, n- and isopropanol, n- and isobutanol, especially isopropanol and/or isobutanol; hydrocarbons such as toluene and especially aromatic hydrocarbons (e.g., benzenes) with a boiling range from 60 to 120° C.; ketones, especially acetone, methyl ethyl ketone, methyl isobutyl ketone; esters such as ethyl acetate, and mixtures of the aforementioned solvents. Particularly preferred solvents are mixtures containing isopropanol in amounts of 2% to 15% by weight, especially of 3% to 10% by weight, based in each case on the solvent mixture used.

After the preparation of the poly(meth)acrylates, either they may be processed further from solution, or a concentration takes place, and the further processing of the poly(meth)acrylates is substantially solvent-free. The concentration of the polymer may take place in the absence of crosslinker and accelerator substances. It is, though, also possible for one of these classes of compound to be added to the polymer even before the concentration, in which case the concentration takes place in the presence of these one or more substances. After the concentrating step, the polymers may be transferred to a compounder. Where appropriate, concentration and compounding may also take place in the same reactor.

The weight-average molecular weights (weight averages of the molecular weight distribution) M_{w} of the one or more poly(meth)acrylates are preferably within a range from 20000 to 2000000 g/mol, more preferably within a range from 100000 to 1500000 g/mol, especially preferably within a range from 150000 to 1000000 g/mol. For this purpose, it may be advantageous to conduct the polymerization in the presence of suitable chain transfer agents such as thiols, halogen compounds and/or alcohols in order to establish the desired average molecular weight. With such an M_{w}, including all preference levels, of the one or more poly(meth)acrylates, sufficient cohesion in conjunction with good flowability and good adhesion are achieved in the adhesive, on the understanding that in terms of the profile of the stated properties, the adhesive is optimized to a higher degree when the preference level is higher. The M_{w} is determined by GPC as described in the Test Methods.

The poly(meth)acrylates preferably have a K value of 30 to 90, more preferably of 40 to 70, measured in toluene (1% solution, 21° C.). Fikentscher's K value is a measure of the molecular weight and the viscosity of polymers. The principle of the method is based on the determination of the relative solution viscosity by capillary viscometry. For this purpose, the test substance is dissolved in toluene by shaking for 30 minutes, to give a 1% solution. In a Vogel-Ossag viscometer, at 25° C., the flow time is measured and this is used to determine the relative viscosity of the sample solution with respect to the viscosity of the pure solvent. The Fikentscher K value can be read off from tables (K=1000 k). (See P. E. Hinkamp, Polymer, 1967, vol. 8, p. 381.)

The poly(meth)acrylate preferably has a polydispersity PD<4 and hence a relatively narrow molecular weight distribution. Compositions based thereon, in spite of a relatively low molecular weight, after crosslinking have particularly good shear strength. Moreover, the relatively low polydispersity enables easier processing from the melt since the flow viscosity is lower compared to a poly(meth)acrylate of broader distribution, with largely the same applications properties. Poly(meth)acrylates having a narrow distribution can advantageously be prepared by anionic polymerization or by controlled radical polymerization methods, the latter being of particularly good suitability. It is also possible to prepare corresponding poly(meth)acrylates via N-oxyls. In addition, it is advantageously possible to use atom transfer radical polymerization (ATRP) for synthesis of narrow-distribution poly(meth)acrylates, preferably using monofunctional or difunctional, secondary or tertiary halides as initiator, and complexes of Cu, Ni, Fe, Pd, Pt, Ru, Os, Rh, Co, Ir, Ag or Au for abstraction of the halides. RAFT polymerization is also suitable.

The poly(meth)acrylates are preferably crosslinked by linkage reactions—especially in the form of addition or substitution reactions—of functional groups present therein, such as more particularly carboxylic acid groups, with thermal crosslinkers. An advantage of this approach is that the adhesive is not too soft and exhibits not too high a cold flow. This is beneficial to the cohesion of the adhesive and also to the storage and workability of the adhesive.

It is possible to use any thermal crosslinkers which both assure a sufficiently long working time, such that there is no gelation during the processing operation, especially the extrusion operation, and lead to rapid post-crosslinking of the polymer to the desired degree of crosslinking at lower temperatures than the processing temperature, especially at room temperature.

Possible, for example, is a combination of polymers containing carboxyl (carboxylic acid), amino and/or hydroxyl groups with isocyanates, more particularly aliphatic or blocked isocyanates, examples being amine-deactivated trimerized isocyanates, as crosslinkers. Suitable isocyanates are, in particular, trimerized derivatives of MDI [4,4-methylenedi(phenyl isocyanate)], HDI [hexamethylene diisocyanate, 1,6-hexylene diisocyanate], and IPDI [isophorone diisocyanate, 5-isocyanato-1-isocyanatomethyl-1,3,3-trimethylcyclohexane]. Preference is given to using thermal crosslinkers at 0.1% to 5% by weight, more particularly at 0.2% to 1% by weight, based on the total amount of the polymer to be crosslinked.

Another possibility is that of crosslinking via complexing agents, also referred to as chelates. An example of a preferred complexing agent is aluminum acetylacetonate.

The poly(meth)acrylates are crosslinked preferably by means of epoxide(s), or by means of one or more substances containing epoxide groups. This ensures durable, irreversible crosslinking. The substances containing epoxide groups are more particularly polyfunctional epoxides, i.e., those having at least two epoxide groups; the overall result, accordingly, is an indirect linking of the units in the poly(meth)acrylates that carry the functional groups. The substances containing epoxide groups may be both aromatic and aliphatic compounds.

Outstandingly suitable polyfunctional epoxides are oligomers of epichlorohydrin, epoxy ethers of polyhydric alcohols, especially of ethylene glycol, propylene glycol and butylene glycol, polyglycols, thiodiglycols, glycerol, pentaerythritol, sorbitol, polyvinyl alcohol, polyallyl alcohol and the like; epoxy ethers of polyhydric phenols, especially of resorcinol, hydroquinone, bis(4-hydroxyphenyl)methane, bis(4-hydroxy-3-methylphenyl)methane, bis(4-hydroxy-3,5-dibromophenyl)methane, bis(4-hydroxy-3,5-difluorophenyl)methane, 1,1-bis(4-hydroxyphenyl)ethane, 2,2-bis(4-hydroxyphenyl)propane, 2,2-bis(4-hydroxy-3-methylphenyl)propane, 2,2-bis(4-hydroxy-3-chlorophenyl)propane, 2,2-bis(4-hydroxy-3,5-dichlorophenyl)propane, bis(4-hydroxyphenyl)phenylmethane, bis(4-hydroxyphenyl)diphenylmethane, bis(4-hydroxyphenyl)-4′-methylphenylmethane, 1,1-bis(4-hydroxyphenyl)-2,2,2-trichloroethane, bis(4-hydroxyphenyl) (4-chlorophenyl)methane, 1,1-bis(4-hydroxyphenyl)cyclohexane, bis(4-hydroxyphenyl)cyclohexylmethane, 4,4′-dihydroxydiphenyl, 2,2′-dihydroxydiphenyl, 4,4′-dihydroxydiphenyl sulfone and the hydroxyethyl ethers thereof; phenol-formaldehyde condensation products such as phenol alcohols and phenol-aldehyde resins; S- and N-containing epoxides, for example N,N-diglycidylaniline, N,N′-dimethyldiglycidyl-4,4-diaminodiphenylmethane, tetraglycidyl-meta-xylenediamines; and epoxides that have been prepared by customary methods from polyunsaturated carboxylic acids or monounsaturated carboxylic esters of unsaturated alcohols; glycidyl esters; and polyglycidyl esters, which can be obtained by polymerization or copolymerization of glycidyl esters of unsaturated acids or are obtainable from other acidic compounds, for example from cyanuric acid, diglycidyl sulfide or cyclic trimethylene trisulfone or derivatives thereof.

Examples of very suitable ethers are butane-1,4-diol diglycidyl ether, polyglycerol-3 glycidyl ether, cyclohexanedimethanol diglycidyl ether, glycerol triglycidyl ether, neopentyl glycol diglycidyl ether, pentaerythritol tetraglycidyl ether, hexane-1,6-diol diglycidyl ether, polypropylene glycol diglycidyl ether, trimethylolpropane triglycidyl ether, pentaerythritol tetraglycidyl ether, bisphenol A diglycidyl ether, and bisphenol F diglycidyl ether. Other preferred epoxides are cycloaliphatic epoxides such as 3,4-epoxycyclohexylmethyl 3,4-epoxycyclohexanecarboxylate (UVACure 1500).

Preferred embodiments use tetraglycidyl-meta-xylenediamine as crosslinker.

According to preferred embodiments, the poly(meth)acrylates are crosslinked by means of a crosslinker-accelerator system (“crosslinking system”), in order to obtain better control over the working time, crosslinking kinetics, and degree of crosslinking. The crosslinker-accelerator system preferably comprises at least one substance containing epoxide groups as crosslinker, and at least one substance having accelerating action for crosslinking reactions at a temperature below the melting temperature of the polymer to be crosslinked, by means of compounds containing epoxide groups, as accelerator.

Accelerators used in the invention are more preferably amines. These should be regarded in a formal sense as substitution products of ammonia; the substituents especially include alkyl and/or aryl radicals. Particular preference is given to using those amines that enter into only a low level of reactions, if any, with the polymers to be crosslinked. In principle, accelerators chosen may be primary (NRH₂), secondary (NR₂H) or else tertiary amines (NR₃), and of course also those having multiple primary and/or secondary and/or tertiary amino groups. Particularly preferred accelerators are tertiary amines such as, for example, triethylamine, triethylenediamine, benzyldimethylamine, dimethylaminomethylphenol, 2,4,6-tris(N,N-dimethylaminomethyl) phenol, and N,N′-bis(3-(dimethylamino) propyl) urea. Further preferred accelerators are polyfunctional amines such as diamines, triamines and/or tetramines, for example diethylenetriamine, triethylenetetramine, and trimethylhexamethylenediamine.

Further preferred accelerators are amino alcohols, especially secondary and/or tertiary amino alcohols, where in the case of two or more amino functionalities per molecule, preferably at least one and more preferably all of the amino functionalities are secondary and/or tertiary. Particularly preferred such accelerators are triethanolamine, N,N-bis(2-hydroxypropyl)ethanolamine, N-methyldiethanolamine, N-ethyldiethanolamine, 2-aminocyclohexanol, bis(2-hydroxycyclohexyl)methylamine, 2-(diisopropylamino)ethanol, 2-(dibutylamino)ethanol, N-butyldiethanolamine, N-butylethanolamine, 2-[bis(2-hydroxyethyl)amino]-2-(hydroxymethyl)-1,3-propanediol, 1-[bis(2-hydroxyethyl)amino]-2-propanol, triisopropanolamine, 2-(dimethylamino)ethanol, 2-(diethylamino)ethanol, 2-(2-dimethylaminoethoxy)ethanol, N,N,N′-trimethyl-N′-hydroxyethylbisaminoethyl ether, N,N,N′-trimethylaminoethylethanolamine, and N,N,N′-trimethylaminopropylethanolamine.

Further suitable accelerators are pyridine, imidazoles, for example 2-methylimidazole, and 1,8-diazabicyclo[5.4.0]undec-7-ene. It is also possible to use cycloaliphatic polyamines as accelerators. Also suitable are phosphorus-based accelerators such as phosphines and/or phosphonium compounds, for example triphenylphosphine or tetraphenylphosphonium tetraphenylborate.

It is also possible to use quaternary ammonium compounds as accelerators; examples are tetrabutylammonium hydroxide, cetyltrimethylammonium bromide, and benzalkonium chloride.

The first layer D of adhesive contains preferably 2% to 10% by weight, with particular preference 4% to 6% by weight, of electrolytes, preferably ionic liquids, based on 100% by weight of polymers contained, with preferably 100% by weight of the polymers being poly(meth)acrylates. With such a preferred or particularly preferred amount of electrolytes, especially ionic liquids, comparatively quick electrical detachment becomes possible, while at the same time there is no adverse effect on the adhesion of the layer of adhesive to the substrate prior to the detachment.

The adhesive of the first layer D of adhesive may additionally comprise further customary additives, such as tackifier resins, plasticizers, compatibilizers, and fillers. Compatibilizers used are preferably low molecular weight polyethers, polyamines, polyvinylpyrrolidones or aliphatic polyesters which are homogeneously miscible with the adhesive. Certain plasticizers may also at the same time be compatibilizers, an example being polyethylene glycol (PEG).

According to particularly preferred embodiments, the adhesive of the first layer D of adhesive contains at least one polyether, preferably at least one substance selected from the group consisting of polyethylene glycol (PEG), polypropylene glycol (PPG), and polytetrahydrofuran, with PEG and PPG being particularly preferred. This provides particularly effective assistance for the detachability. Without wishing to be tied to any particular theory, it is conceivable that the stated substances, especially PEG, accelerate the flow of ions from the one or more electrolytes through the layer of composition.

The molecular weight (by GPC) of the stated substances here is preferably between 100 and 5000 g/mol, with particular preference between 200 and 2000 g/mol. The skilled person is aware that PEG and PPG are available with various molecular weights M_{w}, as for example PEG 400 or PPG 600, with the number indicating the M_{w}.

The carrier layer T is electrically conductive. The electrically conductive carrier layer T preferably comprises at least one metal. With particular preference, the metal is selected from the group consisting of copper, nickel, zinc, tin, silver, gold, aluminum, iron, chromium, and alloys of these stated metals. With especial preference, the metal is selected from the group consisting of aluminum, copper, and nickel. The electrically conductive carrier layer T preferably has a layer thickness, measured in z direction, i.e., parallel to the stack direction of the layered arrangement, of 10 nm (nanometers) to 50 μm (micrometers) auf.

According to preferred embodiments of the invention, the electrically conductive carrier layer T includes a) at least one metal foil, preferably an aluminum foil, and/or b) at least one electrically conductive textile including at least one metal, preferably selected from the group consisting of copper and nickel, and/or c) one or more layers of at least one metal applied by vapor deposition, preferably selected from the group consisting of copper and aluminum, and/or d) at least one mesh of metal. It is also conceivable here in principle for the layer T to include a combination of two or more of the stated possibilities.

Metal foils, for example, and preferably aluminum foils, are known to the skilled person. The metal foil, for example and preferably the aluminum foil, preferably has a layer thickness, measured in z direction, i.e., parallel to the stack direction of the layered arrangement, of 5 to 50 μm, with particular preference of 10 to 30 μm.

Electrically conductive textiles are known to the skilled person, especially as “conductive mesh”. This is a woven textile fabric, for example of PET (polyethylene terephthalate), coated with a metal, for example with copper and/or nickel, to establish the electrical conductivity of the fabric.

The skilled person is likewise aware that metals may be applied, directly as a single layer or multiple layers, to faces, such as here the surface of a layer of adhesive, by vapor deposition. In the context of the present invention, the carrier layer T may be provided by vapor deposition of metal onto the layer D or the layer C of adhesive. In this case, the layer thickness of the layer T is preferably greater than or equal to 10 nm (nanometers), with preference to a thickness from 50 to 200 nm.

Furthermore, the skilled person knows of metal meshes in a variety of dimensions. Metal meshes having suitable layer thicknesses may be produced, for example, by a laid scrim of appropriately thin metal threads, or by diecutting of at least one foil of suitable layer thickness.

In accordance with the invention, the adhesive tape comprises a second layer C of adhesive, the layer C of adhesive being electrically conductive. The electrically conductive layer C of adhesive for this purpose preferably contains at least one metal, such as more particularly nickel, copper, silver, preferably in the form of electrically conductive metal particles and/or metallized particles, with particular preference metal particles.

Metallized particles are, in particular and preferably, glass or polymer particles metallized with at least one metal to render the hitherto electrically nonconductive particles electrically conductive as a result of the metallization. With particular preference, the electrically conductive layer C of adhesive contains electrically conductive particles selected from the group consisting of nickel particles, copper particles, and silvered copper particles. According to particularly preferred embodiments, the electrically conductive layer of adhesive contains nickel particles.

The electrically conductive layer C of adhesive contains preferably 5% to 40% by weight, with particular preference 20% to 40% by weight, especially preferably 25% to 35% by weight, of electrically conductive particles, more particularly metal particles and/or metallized particles, based on 100% by weight of polymers and tackifier resins contained.

The electrically conductive particles ought preferably to be no greater or not markedly greater than the thickness of the layer C of adhesive in z direction, measured with the light microscope. The electrically conductive particles preferably have an average particle size of 1 to 20 μm, with particular preference of 1 to 10 μm, preferably in turn of 3 to 5 μm, such as more particularly 4 μm.

The layer C is more particularly electrically conductive, at least in z direction. It may, however, also be electrically conductive in the xy plane. If the layer C is configured for electrical conductivity only in z direction, but not necessarily in xy direction, then according to preferred embodiments, in which a metal, more particularly metal particles, is/are added to achieve the electrical conductivity, the amount of these materials required is lower. As a result, the adhesive is optimized in terms of required conductivity, peel adhesion, flow characteristics, and costs. A layer is considered in the context of the present invention to be “electrically conductive” in particular when the resistance is less than 1 ohm, measured in the respective direction, here in particular in z direction, according to the military specification MIL-DTL-83528C.

The composition in the layer C of adhesive may otherwise in principle be any adhesive which can be rendered electrically conductive and in which preferably metal particles can be homogeneously distributed. The layer C of adhesive here, according to preferred embodiments of the invention, is poly(meth)acrylate-based, like the layer D of adhesive. This is subject to all of the above statements regarding the definition and the nature and amount of poly(meth)acrylate-based and poly(meth)acrylates, respectively. According to preferred embodiments, the poly(meth)acrylate used in the layer C of adhesive is the same as in the layer D of adhesive. As a result, in particular, similar substrates, identified here as A and B, can be bonded to one another. As a result, further, the aging resistance and temperature stability of the adhesive tape are increased.

According to further preferred embodiments of the invention, a polymer is used in the layer C of adhesive that is different from the poly(meth)acrylate used in the layer D of adhesive. This allows the properties of the conductive layer to be adapted particularly well to the substrate which is bonded by way of the layer C of adhesive. Because the layer C of adhesive does not or need not preferably contain any electrolyte, such as an ionic liquid, there is no need for the constituents to be harmonized in this respect. According to further preferred embodiments of the invention, therefore, a poly(meth)acrylate is used in the layer C of adhesive that is different from the poly(meth)acrylate used in the layer D of adhesive.

According to further preferred embodiments of the invention, at least one vinyl aromatic block copolymer is contained in the layer C of adhesive. According to preferred embodiments of the invention, the layer C of adhesive is based on vinyl aromatic block copolymer(s), meaning that, according to these embodiments, vinyl aromatic block copolymers constitute the main polymers in the layer C of adhesive and in that case are contained at 70% to 100% by weight, based, that is, on 100% by weight of polymers contained in the layer C. Any tackifier resins contained in the layer C of adhesive are, in the context of this calculation, not counted as part of the 100% by weight of polymers contained.

The one or more vinyl aromatic block copolymers may in principle be any types known to the skilled person. The vinyl aromatic block copolymers preferably have the structure A-B, A-B-A and/or (A-B)ₙX, where X is a radical of a coupling reagent or initiator and n is greater than or equal to 2. With particular preference, the one or more vinyl aromatic block copolymers have the structure A-B-A, optionally in a blend with fractions of A-B, the latter constituting the diblock fraction.

With particular preference, the one or more vinyl aromatic block copolymers are present as a blend of polymers of the structure A-B-A with polymers of the structure A-B. The blocks A constitute the blocks prepared from vinyl aromatic monomers. The blocks A are preferably prepared from a polymerization mixture containing at least styrene and α-methylstyrene, preferably prepared from a polymerization mixture containing at least styrene. With particular preference, the blocks A are blocks prepared from styrene and hence are polystyrene blocks. The blocks B constitute the remaining blocks of the block copolymer. The blocks B are preferably prepared from a polymerization mixture containing monomers such as 1,3-dienes and isobutylene, more preferably prepared from a polymerization mixture containing butadiene and/or isoprene. With particular preference, the blocks B are blocks prepared from butadiene and hence are polybutadiene blocks. With particular preference, the one or more vinyl aromatic block copolymers are styrene block copolymers, in turn preferably styrene-butadiene block copolymers of the structure A-B-A and optional fractions of A-B. This provides a particularly good achievement of the object on which the invention is based.

According to particularly advantageous embodiments, the vinyl aromatic block copolymer in the layer of pressure-sensitive adhesive is a mixture of at least two styrene-butadiene block copolymers, with a first block copolymer having a diblock fraction A-B of 50% to 85% and a second block copolymer having a diblock fraction A-B of 5% to 35%. This provides a particularly good achievement of the object on which the invention is based. The diblock fraction is determined via GPC and, as the skilled person is aware, may be customized through the choice of suitable preparation processes.

The weight average of the molecular weight distribution M_{w} (by GPC) of the A-B-A polymer strands in the one or more vinyl aromatic block copolymers contained is preferably from 50000 g/mol to 300000 g/mol, with particular preference from 80000 to 180000 g/mol.

According to preferred embodiments of the invention, the layer C of adhesive includes at least one tackifier resin, especially if the layer is based on vinyl aromatic block copolymers as main polymers. This raises the tack of the adhesive, and does so without going against the object on which the invention is based. Accordingly, the layer C of adhesive is still conductive. A “tackifier resin” in accordance with the understanding of the skilled person refers to an oligomeric or polymeric resin that increases the adhesion (the tack, the intrinsic stickiness) of the layer of adhesive by comparison with the otherwise identical layer of adhesive containing no tackifier resin.

The at least one tackifier resin preferably has a weight-average molecular weight M_{w} of 400 to 15000 g/mol, with particular preference of 400 to 5000 g/mol, especially preferably of 500 to 2000 g/mol. The at least one tackifier resin is preferably selected from the group consisting of unhydrogenated or partially or fully hydrogenated resins based on rosin or rosin derivatives, hydrogenated polymers of dicyclopentadiene, non-hydrogenated, partially, selectively, or fully hydrogenated hydrocarbon resins based on C-5, C-5/C-9 or C-9 monomer mixtures, and polyterpene resins based on α-pinene and/or β-pinene and/or δ-limonene. To the skilled person it is clear that they may select a tackifier resin that can be mixed homogeneously in particular with the one or more vinylaromatic block copolymers.

The adhesive of the second layer C may further comprise other customary additives, such as plasticizers and fillers.

According to preferred embodiments, either or both of the first layer D of adhesive and the second layer C of adhesive is or are foamed. Foaming improves the shock resistance of the adhesive tape of the invention and hence of the bonded assembly as well. This ensures that there is no premature, unwanted detachment of the substrates, particularly if the bonded assembly is exposed to forces, as a result of being dropped, for example. The foaming is produced preferably by means of microballoons; in the case of the electrically detachable layer D, the microballoons have a layer of silicate or aluminosilicate on their surface.

“Microballoons” are hollow microspheres which are elastic and can therefore be expanded in their base state, having a thermoplastic polymer shell. These spheres are filled with low-boiling liquids or liquefied gas. Shell materials used include, in particular, polyacrylonitrile, PVDC, PVC or polyacrylates. Suitable low-boiling liquids or gases are, in particular, hydrocarbons of the lower alkanes, isobutane or isopentane for example, which are enclosed as a liquefied gas under pressure in the polymer shell; isopentane is particularly preferred.

Exposure of the microballoons, more particularly an exposure to heat, causes the outer polymer shell to soften. At the same time, the liquid propellant gas within the shell undergoes transition to its gaseous state. The microballoons here expand irreversibly, the expansion being three-dimensional. Expansion is at an end when the internal pressure matches the external pressure. Since the polymeric shell is retained, the result is a closed-cell foam.

Microballoons are available commercially in a multiplicity of types, which may be differentiated essentially by way of their size (6 to 45 μm diameter in the unexpanded state) and by way of the onset temperatures they require for expansion (75 to 220° C.). Examples of commercially available microballoons are the Expancel® DU products (DU=dry unexpanded) from Nouryon or the Microsphere® FN products from Matsumoto. For stabilization, the microballoons frequently possess an inorganic layer on their surface. This may be, for example, a silicate or an aluminosilicate. Alternatively, carbonates such as calcium carbonate may be used, or various oxides.

It has surprisingly emerged in the context of the present invention that an electrically detachable layer D of adhesive which for that purpose contains electrolytes and which at the same time is foamed can be produced only with microballoons which at their surface have a layer of silicate or aluminosilicate. Silicates are the salts of ortho-silicic acid (Si(OH)₄) and the condensates thereof. All these salts are compounds constructed of SiO₄ tetrahedra, but in which the tetrahedra can be linked to one another in a variety of ways. Positions on the tetrahedral that are unlinked contribute to charge compensation of metal cations or may be present in the form of hydroxide ions (OH). Aluminosilicates are the collective designations for chemical compounds from the group of the silicates that are constructed from SiO₄ tetrahedra und AlO₄ tetrahedra as the base units.

A further possible distinction is between unexpanded and pre-expanded microballoons. In the context of the present invention, it is possible in principle to conceive of using unexpanded and/or pre-expanded microballoons. Unexpanded microballoons are added typically in the unexpanded state to a composition, with expansion taking place only subsequently, in particular as a result of heating. Unexpanded microballoon types are also available in the form of an aqueous dispersion having a solids or microballoon fraction of around 40% to 45% by weight, and also in the form of polymer-bound microballoons (masterbatches), for example in ethylene-vinyl acetate with a microballoon concentration of around 65% by weight. Both the microballoon dispersions and the masterbatches, like the DU types, are suitable for production of a foamed adhesive.

Foamed layers of adhesive may also be produced with what are called pre-expanded microballoons. In the case of pre-expanded microballoons, expansion takes place as early as before incorporation into the polymer matrix. Pre-expanded microballoons are commercially available, for example, under the Dualite® name. In the processing of already expanded microballoon types, it may be the case that the microballoons have a tendency to flotation on account of their low density in the polymer matrix into which they are to be incorporated, i.e., float “upward” in the polymer matrix during the processing operation. This leads to irregular distribution of the microballoons in the layer. In the upper region of the layer (z direction), more microballoons are encountered than in the lower region of the layer, such that a density gradient is established over the layer thickness.

In order to largely or virtually completely prevent such a density gradient, preference is given in accordance with the invention to incorporating microballoons into the polymer matrix of the layers of adhesive, which microballoons have only been lightly pre-expanded, if at all, and are therefore expandable. Only after incorporation into the layer are the microballoons expanded. This results in a more uniform distribution of the microballoons in the polymer matrix. Expansion of the expandable microballoons then takes place only after or directly on incorporation, producing the foaming. In the case of solvent-containing compositions, the microballoons are preferably expanded only after incorporation, coating, drying (solvent evaporation).

According to preferred embodiments of the invention, therefore, the first layer D of adhesive and/or the second layer C of adhesive are/is foamed, with the foaming produced via expansion of expandable microballoons, the expandable microballoons having at their surface a layer of silicate or aluminosilicate. The mean diameter of the cavities formed by the microballoons in the one or more foamed layers of adhesive is preferably 10 to 200 μm, particularly preferably from 15 to 200 μm, very preferably 15 to 150 μm, preferably in turn from 20 to 100 μm, particularly preferably in turn from 25 to 70 μm. With the stated preferred and particularly preferred size ranges, the shock resistance achieved is particularly good. At the same time, the sizes are adapted in terms of the layer thicknesses of the layer or layers of adhesive.

Since the diameters of the cavities formed by the microballoons in the foamed layers of adhesive are being measured here, the diameters are those diameters of the cavities formed by the expanded microballoons. The mean diameter here means the arithmetic mean of the diameters of the cavities formed by the microballoons in the layer of adhesive. The mean diameter of the cavities formed by the microballoons in a layer of adhesive is determined with reference to 5 different cryofracture edges of the adhesive tape under a scanning electron microscope (SEM) at 500 times magnification. The diameters of the microballoons visible on the micrographs are ascertained graphically in such a way that, for each individual microballoon in the layer of adhesive under investigation, the maximum extent thereof in an arbitrary (two-dimensional) direction is taken from the SEM micrographs and deemed to be the diameter of that microballoon.

If foaming takes place by means of microballoons, the microballoons may be supplied to the formulation in the form of a batch, a paste or a blended or neat powder. In addition, they may be suspended in solvents. The fraction of the microballoons in the layer or layers of adhesive, according to preferred embodiments of the invention, is between greater than 0% and 12% by weight, particularly preferably between 0.25% and 5% by weight, especially preferably between 0.5% and 3% by weight, based in each case on the overall composition (including incorporated microballoons) of the layer in question. The figures are based in each case on unexpanded microballoons. The quantities stated represent a particularly good resolution of the conflict in objectives between the properties of tack, flow characteristics, and foaming.

A polymer composition of the layer or layers of adhesive that contains expandable hollow microspheres may additionally also contain non-expandable hollow microspheres. All that matters is that virtually all gas-containing caverns are closed by a permanently impervious membrane, no matter whether this membrane consists of an elastic and thermoplastically extensible polymer mixture or, for instance, of elastic glass that is non-thermoplastic over the spectrum of temperatures possible in plastics processing. Also suitable for the layers of adhesive—and chosen independently of other additives—are solid polymer beads such as PMMA beads, hollow glass beads, solid glass beads, phenolic resin beads, hollow ceramic beads, solid ceramic beads and/or solid carbon beads (“carbon microballoons”).

The absolute density of the foamed layer or layers of adhesive is preferably 350 to 950 kg/m³, more preferably 450 to 930 kg/m³, very preferably 570 to 880 kg/m³. Relative density describes the ratio of the density of the respective foamed layer to the density of the corresponding unfoamed layer having the identical formula. The relative density of the layer or layers of adhesive is preferably 0.35 to 0.99, more preferably 0.45 to 0.97, especially 0.50 to 0.90.

The adhesive of the layer D of adhesive is preferably a pressure-sensitive adhesive, and the layer D of adhesive is therefore preferably a layer D of pressure-sensitive adhesive. This allows the adhesive tape to be easily bonded at this side, in particular since no introduction of heat is required, in comparison to heat-activatable adhesive systems. Further, the constituents of the electrolyte, such as more particularly the ions of ionic liquids, migrate more rapidly in pressure-sensitive adhesives, owing to the comparatively low crosslinking densities. According to preferred embodiments, the adhesive of the layer C of adhesive is not a pressure-sensitive adhesive.

According to further preferred embodiments of the invention, the adhesive of the layer C of adhesive is a pressure-sensitive adhesive and the layer C of adhesive is therefore a layer C of pressure-sensitive adhesive. In the embodiments in which both the layer D of adhesive and the layer C of adhesive are layers of pressure-sensitive adhesive, the adhesive tape of the invention is a pressure-sensitive adhesive tape.

The meaning of the term “pressure-sensitive adhesive” presently in accordance with the invention is the generally accepted meaning: a substance which—in particular at room temperature—is durably tacky and adhesive. A pressure-sensitive adhesive composition has the characteristic feature that it can be applied by pressure to a substrate and continues to adhere thereon; neither the pressure that has to be exerted nor the duration of exposure to said pressure is defined in any more detail. In some cases, depending on the precise type of pressure-sensitive adhesive, on the temperature and the humidity, and also on the substrate, a short period of exposure to a minimal pressure not exceeding gentle contact for a brief moment is sufficient to achieve the adhesion effect; in other cases, there may also be a need for more prolonged exposure to a high pressure.

Pressure-sensitive adhesives (PSAs) have particular, characteristic viscoelastic properties which provide the durable tack and adhesion. They are characterized in that mechanical deformation results not only in viscous flow processes but also in build-up of elastic recovery forces. There is a particular relationship between the respective components provided by the two processes, this being dependent not only on the precise composition, on the structure and on the degree of crosslinking of the pressure-sensitive adhesive but also on the deformation rate and deformation time, and on the temperature.

The viscous flow component is necessary in order to achieve adhesion. The viscous components deriving from macromolecules with relatively high freedom of motion are solely responsible for good wetting and good flow onto the substrate requiring adhesive bonding. A large viscous flow component leads to high tack (also known as surface tack) and with this often also high peel adhesion. Highly crosslinked systems, and crystalline or glassy polymers, generally exhibit no tack or at least only little tack because they have insufficient flowable components.

The components providing elastic recovery forces are necessary to achieve cohesion. They can derive by way of example from macromolecules that have very long chains and are highly intertwined, and/or from macromolecules that have been physically or chemically crosslinked, and they permit transmission of the forces acting on an adhesive bond. They allow an adhesive bond to withstand, to a sufficient extent for a prolonged period, a long-term load to which it is exposed, for example taking the form of a long-term shear load.

The magnitude of elastic and viscous components and the ratio of the components to one another can be described and quantified more precisely by using the variables of storage modulus (G′) and loss modulus (G″), which can be determined by means of dynamic mechanical analysis (DMA, according to International Standard DIN EN ISO 6721). G′ is a measure of the elastic component, and G″ is a measure of the viscous component, of a substance. Both variables depend on deformation frequency and temperature. The variables can be determined with the aid of a rheometer. The material under investigation here is by way of example exposed in a plate-on-plate arrangement to a sinusoidally oscillating shear stress. In the case of shear-stress-controlled equipment, deformation is measured as a function of time, and the time-based offset of this deformation is measured relative to the introduction of the shear stress. This time-based offset is termed phase angle δ. Storage modulus G′ is defined as follows: G′=(τ/γ)·cos(δ) (τ=shear stress, γ=deformation, δ=phase angle=phase shift between shear stress vector and deformation vector). Loss modulus G″ is defined as follows: G″=(τ/γ)·sin(δ) (t=shear stress, γ=deformation, δ=phase angle=phase shift between shear stress vector and deformation vector).

A substance is generally regarded, and defined in the sense of the invention, as exhibiting tack if at room temperature, defined here as 23° C., in the deformation frequency range from 10⁰ to 10¹ rad/sec, G′ is at least to some extent in the range from 10³ to 10⁷ Pa and G″ is likewise at least to some extent in said range. “To some extent” means that at least a section of the G′ curve is within the window defined by the deformation frequency range from, and including, 10⁰ to, and including, 10¹ rad/sec (abscissa) and by the range of the G′ values from, and including, 10³ to, and including, 10⁷ Pa (ordinate). For G″ this applies correspondingly. Preferably, in the deformation frequency range from 10⁰ to 10¹ rad/sec at 23° C., the PSA has a storage modulus G′ and a loss modulus G″ in the range from 10³ to 10⁷ Pa, determined according to DIN EN ISO 6721.

In order to attain the viscoelastic properties, the monomers on which the PSA's parent polymers are based, and also any further components present in the PSA, are selected more particularly such that the PSA has a glass transition temperature (according to test standard DIN 53765) below the temperature of usage (that is, usually, below room temperature (23° C.)). Through suitable cohesion-boosting measures, such as crosslinking reactions (formation of bridge-forming links between the macromolecules), for example, it is possible to expand and/or shift the temperature range within which a polymer composition exhibits pressure-sensitive adhesive properties. The range of usage of the PSAs may therefore be optimized by an adjustment between flowability and cohesion of the composition. The PSA preferably has a glass transition temperature of ≤23° C., determined according to DIN 53765. Unlike pressure-sensitive adhesives, hotmelt adhesives, based for example on polyamides, polyurethanes or modified polyethylenes, do not have any tack at room temperature (23° C.), albeit also in hotmelt adhesive compositions.

The process of the invention for producing the adhesive tape of the invention comprises, as already stated, process steps as follows:
a) providing a first layer D of adhesive, the layer D of adhesive comprising at least one electrolyte;
b) providing an electrically conductive carrier layer T;
c) providing a second layer C of adhesive, the layer C of adhesive being electrically conductive;
d) disposing the layers D, T, and C, to give a layered assembly DTC as a double-sided adhesive tape; and
c) optionally shaping, more particularly diecutting or slitting, the layered assembly DTC.

The provision of the first layer D of adhesive according to step a) is accomplished in particular by providing at least one adhesive and adding at least one electrolyte to this adhesive. The adhesive and the electrolyte are subject to all of the statements above. The adhesive is brought into layer form by means of known methods, in particular, by being coated out. Further, optionally, there may be one or more drying steps.

The provision of the second layer C of adhesive according to step c) is accomplished in particular by providing at least one adhesive which is electrically conductive. For this purpose, the adhesive is preferably admixed with at least one metal, more particularly with electrically conductive metal particles and/or metallized particles, and the metal, more particularly the electrically conductive metal particles and/or metallized particles, is or are distributed homogeneously in the adhesive by mixing. The adhesive and the metal are subject to all of the statements above.

The provision of the carrier layer T according to step b) may be accomplished, as already set out above, in a variety of ways. For instance, it is conceivable for a) a metal foil, more particularly an aluminum foil, and/or b) an electrically conductive net to be placed between the layers D and C. Further, it is possible for c) metal particles to be applied by vapor deposition directly to the surface of the layer D or C of adhesive. The listing of the process steps a) to c) therefore does not necessarily represent a chronological sequence.

It is essential to the invention that the layers according to step d) are disposed three-dimensionally such that the layered assembly DTC is obtained. The adhesive tape preferably consists of the layered assembly DTC. The adhesive tape of the invention more particularly constitutes a double-sided adhesive tape, in which a face of the first layer D of adhesive and a face of the second layer C of adhesive are each available for the bonding of substrates.

The external, exposed faces of the layers D and C of adhesive on the adhesive tape of the invention may advantageously be equipped with non-stick materials such as a release paper or a release film, also called liners. A liner may also comprise material with non-stick coating on at least one side, preferably both sides, such as double-sidedly siliconized material, for example. A liner or, formulated more generally, a temporary carrier is not part of an adhesive tape, but merely a means for its production, storage and/or further processing by diecutting. Furthermore, unlike a permanent carrier, a liner is not fixedly joined to a layer of adhesive, but instead functions as a temporary carrier, i.e., as a carrier which is removable from the layer of adhesive. In the present application, “permanent carriers” are also, simply and synonymously, called “carriers”.

The thickness of the individual layer or layers of adhesive (in z direction) is preferably from 15 to 150 μm, with particular preference from 20 to 100 μm, especially preferably from 25 to 70 μm. The two layers D and C of adhesive here, according to preferred embodiments, have different layer thicknesses, with the thickness of the layer D of adhesive, for example, being lower than that of the layer C of adhesive. According to further preferred embodiments, the layers D and C have the same layer thickness. If the layer thickness of the layer D is too high, it may become unprofitably expensive because of the electrolytes it contains. With regard to the layer thickness of the layer C as well, it must be borne in mind that for a greater layer thickness, a greater quantity of conductive particles are needed in order to ensure the conductivity, particularly in the z direction.

As set out above in the process of the invention for producing the adhesive tape, according to the dimensions that are present and those that are desired, there is an optional step e) of diecutting of the layered assembly DTC.

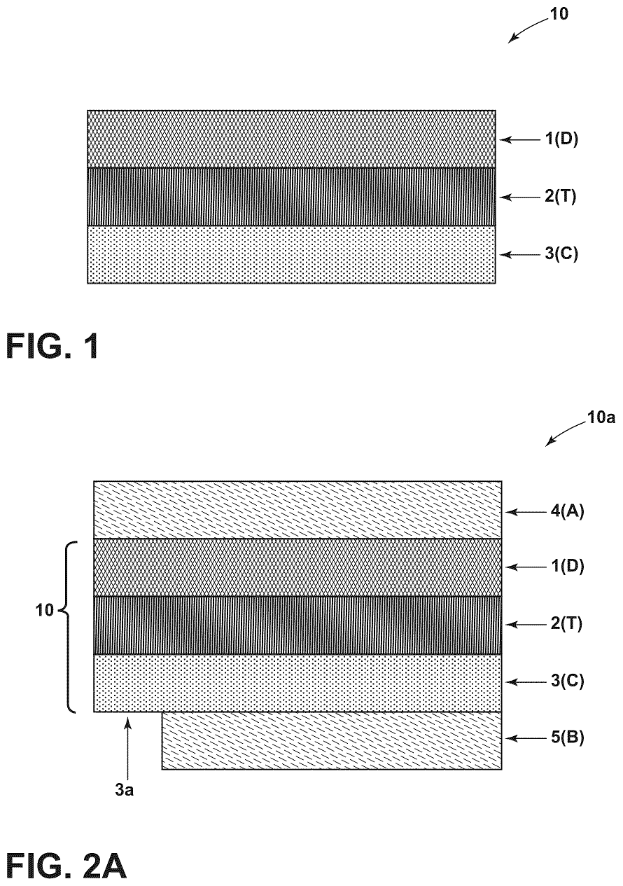

Referring now to FIG. 1, an adhesive tape 10 is provided in which the first adhesive layer 1 (D) is joined by one of its faces to the carrier layer 2 (T). The second adhesive layer 3 (C) is disposed on that face of the carrier layer 2 (T) that is opposite the first adhesive layer 1 (D). As may likewise be recognized in FIG. 1, the adhesive tape 10 constitutes a double-sided adhesive tape, in which an adhesive face of the first adhesive layer 1 (D) and an adhesive face of the second adhesive layer 3 (C) are each available for bonding.

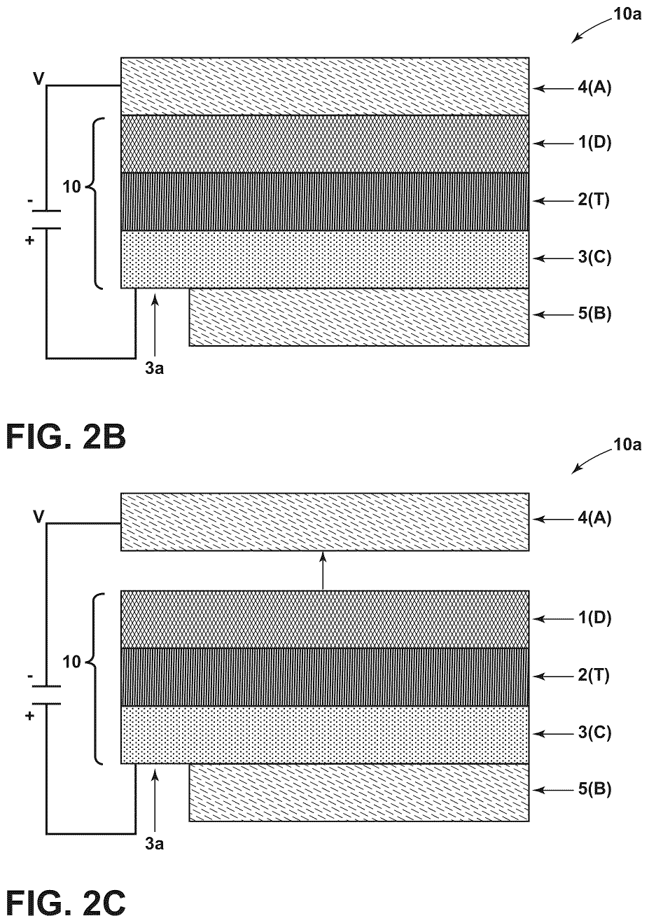

Referring now to FIG. 2A, a schematic representation of the adhesive tape assembly 10a of the invention is provided, according to a preferred embodiment. As may be recognized from FIG. 2, the adhesive tape assembly 10a is configured such that the adhesive tape 10 is disposed by way of the first adhesive layer 1 (D) on a face of the first substrate 4 (A), with the first substrate 4 (A), as detailed earlier in the disclosure, being electrically conductive. Further, the tape assembly 10a is configured such that the tape 10 is disposed by way of the second adhesive layer 3 (C), which is electrically conductive, on a face of a second substrate 5 (B). In this case, adhesive of the second adhesive layer 3 (C) protrudes beyond the second substrate 5 (B) laterally in at least one direction of extent of the layer plane, and so the second adhesive layer 3 (C) in the z direction is partially exposed or has a free face 3a.

Referring now to FIG. 2B, as shown in the figure, a voltage (V) can be applied by way of the free face 3a of the adhesive tape assembly 10a. The application of the voltage (V) causes the electrolyte in the first adhesive layer 1 (D) to migrate, more particularly the anions and cations of an ionic liquid to separate. As a result, the adhesion of the adhesive in the first adhesive layer 1 (D) to the first substrate 4 (A) is greatly reduced and layer 1 (D) and substrate 4 (A) separate from one another, as may be recognized from the schematic representation according to FIG. 2C.

The representations in FIGS. 1 and 2A-2C, as stated, are schematic representations of the inventions of the disclosure. In particular, the layer thicknesses of the individual layers 1 (D), 2 (T), and 3 (C) may deviate from one another. Further, the substrates 4 (A) and 5 (B) as well are represented merely schematically as further layers. These substrates 4 (A) and 5 (B) may of course have any other three-dimensional geometry.

### EXAMPLES

The following examples represent non-limiting examples of the adhesive tape and adhesive tape assemblies of the disclosure, including the methods of making them.

### Test Methods

All measurements are carried out, unless otherwise indicated, at 23° C. and 50% relative humidity. The mechanical and technical adhesive data were ascertained as follows:

Molecular Weight Mₙ, M_{w}

The number-average molecular weight Mₙ and weight-average molecular weight M_{w} data in this specification are based on determination via gel permeation chromatography (GPC). The determination is made on 100 μl of clear-filtered sample (sample concentration 4 g/l). The eluent used is tetrahydrofuran with 0.1% by volume of trifluoroacetic acid. The measurement takes place at 25° C. The pre-column used is a column of type PSS-SDV, 5 μm, 10³ Å, 8.0 mm*50 mm (data here and below in the following order: type, particle size, porosity, internal diameter*length; 1 Å=10⁻¹⁰ m). Separation is performed using a combination of the columns of type PSS-SDV, 5 μm, 10³ Å and also 10⁵ Å and 10⁶ Å each of 8.0 mm*300 mm (columns from Polymer Standards Service; detection via Shodex RI71 differential refractometer). The flow rate is 1.0 ml per minute. Calibration takes place, in the case of polar molecules such as the starting materials of the polyurethane, for example, against PMMA standards (polymethyl methacrylate calibration) and otherwise against PS standards (polystyrene calibration).

### Tackifier Resin Softening Temperature

The tackifier resin softening temperature is implemented in accordance with the relevant methodology, which is known as Ring & Ball and is standardized according to ASTM Standard Test Method E28.

### Thickness

The thickness of a layer of adhesive can be determined by determining the thickness of a section, defined in terms of its length and width, of such an adhesive layer applied to a liner, minus the (known or separately ascertainable) thickness of a section of the same dimensions of the liner used. The thickness of the adhesive layer can be ascertained with accuracies of less than 1 μm deviation using commercially available thickness gauges (sensor test devices). If thickness fluctuations are detected, the mean value of measurements at not less than three representative locations is reported, thus in particular not measured at pinches, folds, specks and the like.

Like the thickness of a layer of adhesive before it, the thickness of an adhesive tape (the adhesive strip) or of a carrier may be ascertained analogously with accuracies of less than 1 μm deviation using commercially available thickness gauges (sensor test devices). If thickness fluctuations are detected, the mean value of measurements at not less than three representative locations is reported, thus in particular not measured at pinches, folds, specks and the like.

### Peel Adhesion—180° Peel Adhesion Test

To test the peel adhesion of the electrically detachable layer D on steel, a 20 mm wide strip of an adhesive tape of the invention is adhered by the electrically conductive adhesive side (layer C) to a 23 μm thick PET film so that the adhesive is slightly protruding. The assembly is applied by the electrically detachable side (layer D) to a steel plate which has previously been washed twice with acetone and once with isopropanol. The pressure-sensitive adhesive strip is pressed onto the substrate twice with a pressing pressure corresponding to a weight of 2 kg. The adhesive tape is thereafter peeled from the substrate immediately with a velocity of 300 mm/min and at an angle of 180°. All measurements are carried out at room temperature. The results of the peel adhesion test are reported in N/cm as averages from three measurements.

To test the peel adhesion of the electrically conductive layer Con steel, the measurements are carried out analogously, where first a 20 mm wide strip of an adhesive tape of the invention is adhered by the electrically detachable adhesive side (layer D) to a 23 μm thick PET film so that the adhesive is slightly protruding, and subsequently the assembly is applied by the electrically conductive side (layer C) to a steel plate, and so on.

### Example 1

In this example, the layer D of adhesive is provided as follows. A base polymer based on acrylates is first prepared. A reactor conventional for radical polymerizations is charged with 48 kg of 2-ethylhexyl acrylate, 48 kg of n-butyl acrylate, 4 kg of acrylic acid, and 66 kg of benzene/acetone (70/30). After nitrogen gas has been passed through the reactor for 45 minutes, with stirring, the reactor is heated up to 58° C. and 50 g of AIBN are added. The external heating bath is then heated to 75° C. and the reaction is carried out constantly at this external temperature. After 1 h a further 50 g of AIBN are added and after 4 h the reaction mixture is diluted with 20 kg of benzene/acetone mixture. After 5.5 h and again after 7 h, the reaction mixture is re-initiated with in each case 150 g of bis(4-tert-butylcyclohexyl) peroxydicarbonate. After a reaction time of 22 h the polymerization is discontinued and the reaction mixture is cooled to room temperature. The polyacrylate has an average molecular weight of M_{w}=386000 g/mol, with a polydispersity PD (M_{w}/Mₙ)=3.6.

To 100% by weight, based on the amount of the acrylate base polymer without solvent, 5.5% by weight of the ionic liquid 1-ethyl-3-methylimidazolium bis(trifluoromethylsulfonyl)imide (EMIM-TFSI) and 4% by weight of polyethylene glycol 400, from Sigma Aldrich, are added. Additionally, 0.1% by weight, based on the amount of the acrylate polymer without solvent, of the crosslinker Erysis GA 240 is added.

The mixture obtained is then coated out using a coating bar onto a PET liner, equipped with a silicone release, to produce after drying at 110° C. a layer thickness of 50 μm.

The electrically conductive layer C of adhesive is provided as follows. An acrylate base polymer is prepared as described earlier for the layer D of adhesive. 0.1% by weight, based on the amount of the acrylate polymer without solvent, of the crosslinker Erysis GA 240 is added to the acrylate base polymer. To 100% by weight of this acrylate-based polymer, based on the amount of the polymer without solvent, and crosslinker, 30% by weight of nickel particles are added.

An aluminum foil having a layer thickness of 20 μm is provided as electrically conductive carrier layer T. The second layer C of adhesive is then coated out using a coating bar onto the aluminum foil (carrier layer T). The resulting layer thickness of this electrically conductive layer C of adhesive is then likewise 50 μm.

The electrically detachable layer D of adhesive is subsequently laminated onto the aluminum side of the assembly of carrier layer T and electrically conductive layer C of adhesive, to give an adhesive tape with the layered arrangement DTC (Example 1). The overall thickness of the adhesive tape is 120 μm. The peel adhesion of the assembly (Example 1) to steel, determined as set out above, is 4.5 N/cm on the electrically detachable side, i.e., on the free face of the layer D of adhesive, and 5.3 N/cm on the electrically conducting side, i.e., the layer C.

For the test for separation capacity, the adhesive tape (Example 1) is bonded as follows. The separable side of the adhesive tape is adhered to a conductive surface, in this case a steel plate, as a representative of the conductive substrate A. (See also test method “Peel adhesion”.) Adhered to the opposite side is a 23 μm thick PET film, with the plastic part being smaller than the face of the adhesive tape or of the layer C of adhesive, so that the adhesive tape protrudes beyond the plastic part. After bonding, a voltage is then applied, specifically such that the cathode is applied to the steel plate and the anode to the projection or the free face of the electrically conductive layer C of adhesive. The voltage in this case is 12 V and is applied for 60 s. The sample is then immediately clamped into the measuring apparatus and a further measurement is made of the peel adhesion of the layer D of adhesive on the adhesive tape to the steel plate. The peel adhesion now is only 0.7 N/cm. The application of the voltage has enabled a significant reduction in the peel adhesion.

### Example 2

In this second example, the electrically detachable adhesive of the layer D is modified so as to shift the ratio of the acrylates used. In particular, 30 kg of 2-ethylhexyl acrylate, 64 kg of n-butyl acrylate, and 6 kg of acrylic acid are used. As the ionic liquid, 1-ethyl-3-methylimidazolium bis(fluorosulfonyl)imide (EMIM-FSI) is added in an amount of 5% by weight, based on 100% by weight of the acrylate polymer without solvent. Further, 4% by weight, based on 100% by weight of the acrylate polymer (without solvent), of polypropylene glycol 600, from Sigma Aldrich, are added. Additionally, 0.1% by weight, based on the amount of the acrylate polymer without solvent, of the crosslinker Erysis GA 240 is added.

This composition is coated out with a layer thickness of 50 μm onto a siliconized liner.

As the electrically conductive composition of the layer C of adhesive, a composition based on styrene block copolymers is used. The adhesive used is a composition of 33% Kraton D1118, 17% Kraton D1102, and 50% Piccolyte A115. The composition is dissolved in this case in a mixture of benzene and acetone (30/10). To 100% by weight, based on the total amount of polymers and tackifier resin (33% Kraton D1118, 17% Kraton D1102, and 50% Piccolyte A115) without solvent, 30% by weight of nickel particles are added.

The composition is coated out with a resulting layer thickness of 50 μm onto an aluminum foil having a layer thickness of 20 μm, as carrier layer T, as in Example 1.

The electrically detachable layer D is subsequently laminated again onto the remaining free side of the aluminum carrier. The resulting adhesive tape has a peel adhesion to steel of 4.2 N/cm on the electrically detachable side and of 7.7 N/cm on the electrically conductive side. The bonding for the test for redetachability is performed as described above. After application of the voltage of 12 V for 60 s, the peel adhesion of the detachable side (layer D) to the steel is measured again: the peel adhesion drops to 0.4 N/cm.

The substances used in Examples 1 and 2 are as follows:
Kraton™ D1102: styrene-butadiene-styrene block copolymer with the structure A-B-A and A-B in a blend, styrene fraction of 30% and diblock fraction (A-B) of 15%, from Kraton Corporation;
Kraton™ D1118: styrene-butadiene-styrene block copolymer with the structure A-B-A and A-B in a blend, styrene fraction of 31% and diblock fraction (A-B) of 78%, from Kraton Corporation;
Piccolyte® A115 tackifier resin: terpene resin of alpha-pinene, softening point 115° C., from Pinova®;
polyethylene glycol 400, from Sigma-Aldrich;
polypropylene glycol 600, from Sigma-Aldrich;
nickel particles, average particle size 4 μm: T 123, from Vale Canada Ltd; and
Erysis® GA-240: tetraglycidyl-meta-xylenediamine, from Huntsman Advanced Materials.

In FIGS. 1-2C, the following is a list of reference symbols:
1 first layer D of adhesive;
2 carrier layer T;
3 second layer C of adhesive;
3a free face of the second layer C of adhesive;
4 first substrate A;
5 second substrate B;
10 adhesive tape; and
10a adhesive tape assembly.

Embodiment 1. According to Embodiment 1 of the disclosure, an adhesive tape is provided that includes: a first layer of adhesive (D), the layer (D) comprising at least one electrolyte; a second layer of adhesive (C), the layer (C) being electrically conductive; and an electrically conductive carrier layer (T), the carrier layer (T) disposed between the first layer (D) and the second layer (C). Further, the layers (D), (T), and (C) are disposed one above another such that none of the layers (D), (T), and (C) laterally protrudes beyond any of the other layers (D), (T), and (C).

Embodiment 2. According to Embodiment 2 of the disclosure, Embodiment 1 is provided, wherein the at least one electrolyte of the first layer of adhesive (D) is selected from the group consisting of an ionic liquid and a metal salt.

Embodiment 3. According to Embodiment 3 of the disclosure, Embodiment 2 is provided, wherein an anion of the ionic liquid is selected from the group consisting of Br, AlCl₄⁻, Al₂Cl₇⁻, NO₃⁻, BF₄⁻, PF₆⁻, CH₃COO⁻, CF₃COO⁻, CF₃CO₃⁻, CF₃SO₃⁻, (CF₃SO₂)₂N⁻, (CF₃SO₂)₃C⁻, AsF₆⁻, SbF₆⁻, CF₃(CF₂)₃SO₃⁻, (CF₃CF₂SO₂)₂N⁻, CF₃CF₂CF₂COO⁻, and (FSO₂)₂N⁻.

Embodiment 4. According to Embodiment 4 of the disclosure, Embodiment 2 is provided, wherein a cation of the ionic liquid is selected from the group consisting of imidazolium-based cations, pyridinium-based cations, pyrrolidine-based cations, and ammonium-based cations.

Embodiment 5. According to Embodiment 5 of the disclosure, Embodiment 1 is provided, wherein the at least one electrolyte of the first layer of adhesive (D) is selected from the group consisting of the ionic liquids 1-ethyl-3-methylimidazolium bis(trifluoromethylsulfonyl)imide (EMIM-TFSI) and 1-ethyl-3-methylimidazolium bis(fluorosulfonyl)imide (EMIM-FSI).

Embodiment 6. According to Embodiment 6 of the disclosure, Embodiment 1 is provided, wherein the first layer of adhesive (D) is a poly(meth)acrylate-based adhesive.

Embodiment 7. According to Embodiment 7 of the disclosure, Embodiment 1 is provided, wherein the at least one electrolyte of the first layer of adhesive (D) are 2% to 10% by weight, as based on 100% by weight of polymers contained in the layer (D).

Embodiment 8. According to Embodiment 8 of the disclosure, Embodiment 1 is provided, wherein the electrically conductive carrier layer (T) comprises at least one metal, the at least one metal selected from the group consisting of copper, nickel, zinc, tin, silver, gold, aluminum, iron, chromium, and alloys thereof.

Embodiment 9. According to Embodiment 9 of the disclosure, Embodiment 8 is provided, wherein the electrically conductive carrier layer (T) further comprises one or more of: a) at least one metal foil, b) at least one electrically conductive textile comprising at least one metal, c) one or more layers of at least one metal applied by vapor deposition, and d) at least one mesh of metal.

Embodiment 10. According to Embodiment 10 of the disclosure, Embodiment 1 is provided, wherein the second layer of adhesive (C) comprises at least one metal, the at least one metal selected from the group consisting of metal particles of nickel, copper, silver, and alloys thereof.

Embodiment 11. According to Embodiment 11 of the disclosure, Embodiment 1 is provided, wherein one or both of the first layer of adhesive (D) and the second layer of adhesive (C) are foamed by microballoons, the microballoons comprising a surface having a layer of a silicate or an aluminosilicate.

Embodiment 12. According to Embodiment 12 of the disclosure, a process for producing an adhesive tape is provided that includes: a) providing a first layer of adhesive (D), the layer of adhesive (D) comprising at least one electrolyte; b) providing an electrically conductive carrier layer (T); c) providing a second layer of adhesive (C), the layer of adhesive (C) being electrically conductive; d) disposing the carrier layer (T) between the layers (D) and (C) to define an adhesive tape (DTC), the tape (DTC) configured as a double-sided adhesive tape; and e) optionally shaping the adhesive tape (DTC).

Embodiment 13. According to Embodiment 13 of the disclosure, an adhesive tape assembly is provided that includes: a first substrate (A), the substrate (A) being electrically conductive; a first layer of adhesive (D) disposed on a face of the substrate (A), the layer of adhesive (D) comprising at least one electrolyte; an electrically conductive carrier layer (T) disposed on a face of the first layer of adhesive (D) that is opposite the substrate (A); a second layer of adhesive (C), the layer of adhesive (C) being electrically conductive and being disposed on a face of the carrier layer (T) that is opposite the first layer of adhesive (D); and a second substrate (B), the substrate (B) is disposed on a face of the second layer of adhesive (C) that is opposite the carrier layer (T). The second layer of adhesive (C) laterally protrudes beyond the substrate (B) such that the layer of adhesive (C) has an exposed free face. Further, the layers (D), (T), and (C) are disposed one above another such that none of the layers (D), (T), and (C) laterally protrudes beyond any of the other layers (D), (T), and (C).

Embodiment 14. According to Embodiment 14 of the disclosure, a process for electrically separating an adhesive tape assembly is provided that includes: providing the adhesive tape assembly of Embodiment 13; and applying a voltage (V) between the first substrate (A) and the second layer of adhesive (C), the voltage (V) from 2V to 20V.

Embodiment 15. According to Embodiment 15 of the disclosure, Embodiment 13 is provided, wherein the at least one electrolyte of the first layer of adhesive (D) is selected from the group consisting of an ionic liquid and a metal salt.

Embodiment 16. According to Embodiment 16 of the disclosure, Embodiment 16 is provided, wherein an anion of the ionic liquid is selected from the group consisting of Br, AlCl₄⁻, Al₂Cl₇⁻, NO₃⁻, BF₄⁻, PF₆⁻, CH₃COO⁻, CF₃COO⁻, CF₃CO₃⁻, CF₃SO₃⁻, (CF₃SO₂)₂N⁻, (CF₃SO₂)₃C⁻, AsF₆⁻, SbF₆⁻, CF₃(CF₂)₃SO₃⁻, (CF₃CF₂SO₂)₂N⁻, CF₃CF₂CF₂COO⁻, and (FSO₂)₂N⁻.

Embodiment 17. According to Embodiment 17 of the disclosure, Embodiment 15 is provided, wherein a cation of the ionic liquid is selected from the group consisting of imidazolium-based cations, pyridinium-based cations, pyrrolidine-based cations, and ammonium-based cations.

Embodiment 18. According to Embodiment 18 of the disclosure, Embodiment 13 is provided, wherein the at least one electrolyte of the first layer of adhesive (D) is selected from the group consisting of the ionic liquids 1-ethyl-3-methylimidazolium bis(trifluoromethylsulfonyl)imide (EMIM-TFSI) and 1-ethyl-3-methylimidazolium bis(fluorosulfonyl)imide (EMIM-FSI).

Embodiment 19. According to Embodiment 19 of the disclosure, Embodiment 13 is provided, wherein the first layer of adhesive (D) is a poly(meth)acrylate-based adhesive. Embodiment 20. According to Embodiment 20 of the disclosure, Embodiment 13 is provided, wherein the at least one electrolyte of the first layer of adhesive (D) are 2% to 10% by weight, as based on 100% by weight of polymers contained in the layer (D).

What is claimed is:

1. An adhesive tape, comprising:
a first layer of adhesive (D), the layer of adhesive (D) comprising at least one electrolyte;
a second layer of adhesive (C), the layer of adhesive (C) being electrically conductive; and
an electrically conductive carrier layer (T), the carrier layer (T) disposed between the first layer of adhesive (D) and the second layer of adhesive (C),
wherein the layers (D), (T), and (C) are disposed one above another such that none of the layers (D), (T), and (C) laterally protrudes beyond any of the other layers (D), (T), and (C).

2. The adhesive tape of claim 1, wherein the at least one electrolyte of the first layer of adhesive (D) is selected from the group consisting of an ionic liquid and a metal salt.

3. The adhesive tape of claim 2, wherein an anion of the ionic liquid is selected from the group consisting of Br⁻, AlCl₄⁻, Al₂Cl₇⁻, NO₃⁻, BF₄⁻, PF₆⁻, CH₃COO⁻, CF₃COO⁻, CF₃CO₃⁻, CF₃SO₃⁻, (CF₃SO₂)₂N⁻, (CF₃SO₂)₃C⁻, AsF₆⁻, SbF₆⁻, CF₃(CF₂)₃SO₃⁻, (CF₃CF₂SO₂)₂N⁻, CF₃CF₂CF₂COO⁻, and (FSO₂)₂N⁻.

4. The adhesive tape of claim 2, wherein a cation of the ionic liquid is selected from the group consisting of imidazolium-based cations, pyridinium-based cations, pyrrolidine-based cations, and ammonium-based cations.

5. The adhesive tape of claim 1, wherein the at least one electrolyte of the first layer of adhesive (D) is selected from the group consisting of the ionic liquids 1-ethyl-3-methylimidazolium bis(trifluoromethylsulfonyl)imide (EMIM-TFSI) and 1-ethyl-3-methylimidazolium bis(fluorosulfonyl)imide (EMIM-FSI).

6. The adhesive tape of claim 1, wherein the first layer of adhesive (D) is a poly(meth)acrylate-based adhesive.

7. The adhesive tape of claim 1, wherein the at least one electrolyte of the first layer of adhesive (D) are 2% to 10% by weight, as based on 100% by weight of polymers contained in the layer (D).

8. The adhesive tape of claim 1, wherein the electrically conductive carrier layer (T) comprises at least one metal, the at least one metal selected from the group consisting of copper, nickel, zinc, tin, silver, gold, aluminum, iron, chromium, and alloys thereof.

9. The adhesive tape of claim 8, wherein the electrically conductive carrier layer (T) further comprises one or more of: a) at least one metal foil, b) at least one electrically conductive textile comprising at least one metal, c) one or more layers of at least one metal applied by vapor deposition, and d) at least one mesh of metal.

10. The adhesive tape of claim 1, wherein the second layer of adhesive (C) comprises at least one metal, the at least one metal selected from the group consisting of metal particles of nickel, copper, silver, and alloys thereof.

11. The adhesive tape of claim 1, wherein one or both of the first layer of adhesive (D) and the second layer of adhesive (C) are foamed by microballoons, the microballoons comprising a surface having a layer of a silicate or an aluminosilicate.

12. A process for producing an adhesive tape, comprising:
a) providing a first layer of adhesive (D), the layer of adhesive (D) comprising at least one electrolyte;
b) providing an electrically conductive carrier layer (T);
c) providing a second layer of adhesive (C), the layer of adhesive (C) being electrically conductive;
d) disposing the carrier layer (T) between the layers (D) and (C) to define an adhesive tape (DTC), the tape (DTC) configured as a double-sided adhesive tape; and
e) optionally shaping the adhesive tape (DTC).

13. An adhesive tape assembly, comprising:
a first substrate (A), the substrate (A) being electrically conductive;
a first layer of adhesive (D) disposed on a face of the substrate (A), the layer of adhesive (D) comprising at least one electrolyte;
an electrically conductive carrier layer (T) disposed on a face of the first layer of adhesive (D) that is opposite the substrate (A);
a second layer of adhesive (C), the layer of adhesive (C) being electrically conductive and being disposed on a face of the carrier layer (T) that is opposite the first layer of adhesive (D); and
a second substrate (B), the substrate (B) is disposed on a face of the second layer of adhesive (C) that is opposite the carrier layer (T),
wherein the second layer of adhesive (C) laterally protrudes beyond the substrate (B) such that the layer of adhesive (C) has an exposed free face, and
further wherein the layers (D), (T), and (C) are disposed one above another such that none of the layers (D), (T), and (C) laterally protrudes beyond any of the other layers (D), (T), and (C).

14. A process for electrically separating an adhesive tape assembly, comprising:
providing the adhesive tape assembly of claim 13; and
applying a voltage (V) between the first substrate (A) and the second layer of adhesive (C), the voltage (V) from 2V to 20V.

15. The adhesive tape assembly of claim 13, wherein the at least one electrolyte of the first layer of adhesive (D) is selected from the group consisting of an ionic liquid and a metal salt.

16. The adhesive tape assembly of claim 15, wherein an anion of the ionic liquid is selected from the group consisting of Br⁻, AlCl₄⁻, Al₂Cl₇⁻, NO₃⁻, BF₄⁻, PF₆⁻, CH₃COO⁻, CF₃COO⁻, CF₃CO₃⁻, CF₃SO₃⁻, (CF₃SO₂)₂N⁻, (CF₃SO₂)₃C⁻, AsF₆⁻, SbF₆⁻, CF₃(CF₂)₃SO₃⁻, (CF₃CF₂SO₂)₂N⁻, CF₃CF₂CF₂COO⁻, and (FSO₂)₂N⁻.

17. The adhesive tape assembly of claim 15, wherein a cation of the ionic liquid is selected from the group consisting of imidazolium-based cations, pyridinium-based cations, pyrrolidine-based cations, and ammonium-based cations.

18. The adhesive tape assembly of claim 13, wherein the at least one electrolyte of the first layer of adhesive (D) is selected from the group consisting of the ionic liquids 1-ethyl-3-methylimidazolium bis(trifluoromethylsulfonyl)imide (EMIM-TFSI) and 1-ethyl-3-methylimidazolium bis(fluorosulfonyl)imide (EMIM-FSI).

19. The adhesive tape assembly of claim 13, wherein the first layer of adhesive (D) is a poly(meth)acrylate-based adhesive.

20. The adhesive tape assembly of claim 13, wherein the at least one electrolyte of the first layer of adhesive (D) are 2% to 10% by weight, as based on 100% by weight of polymers contained in the layer (D).
